(19) United States
(12) Patent Application Publication
(10) Pub. No.: US 2023/0393947 A1
(43) Pub. Date: Dec. 7, 2023

(54) ARCHIVING COMPUTING SNAPSHOTS TO MULTIPLE LOCATIONS IN ACCORDANCE WITH A SERVICE LEVEL AGREEMENT

(71) Applicant: Rubrik, Inc., Palo Alto, CA (US)

(72) Inventors: Harshadrai Gajendrakumar Parekh, San Jose, CA (US); Shivam Rajpal, Uttar Pradesh (IN); Nirvan Singhania, West Bengal (IN); Samyak Jain, Rajasthan (IN); Prayag Jain, Madhya Pradesh (IN); Udipta Das, Bengaluru (IN); Vaibhav Choudhary, Rajasthan (IN); Manjunatha D, Chitradurga (IN); Chirag Agarwal, Rajasthan (IN); Pengfei Wang, Fremont, CA (US)

(21) Appl. No.: 17/881,414

(22) Filed: Aug. 4, 2022

(30) Foreign Application Priority Data
Jun. 1, 2022 (IN) 202211031304

(51) Int. Cl. G06F 11/14

(52) U.S. Cl. CPC G06F 11/1461; G06F 11/1448; G06F 2201/84

(57) ABSTRACT

A data management system (DMS) may capture snapshots of a computing object in accordance with a service level agreement (SLA). The DMS may store the captured snapshots in a cluster of storage nodes at the DMS and/or transmit the snapshots to one or more external archive locations. Which archive location to store given snapshots of the computing object may be based on archival policies defined in the SLA. Some snapshots may be stored locally at the DMS, some snapshots may be stored in one archive location of a set of multiple candidate archive locations, and some snapshots may be stored in more than one archive location of the set of multiple candidate archive locations. A retention duration for each snapshot may be independent of the archive location for the snapshot. For recovery purposes, a user may specify from which archive location the user selects to retrieve a snapshot.

### RELATED APPLICATIONS

The present application claims the benefit of Indian Patent Application No. 202211031304, entitled “ARCHIVING COMPUTING SNAPSHOTS TO MULTIPLE LOCATIONS IN ACCORDANCE WITH A SERVICE LEVEL AGREEMENT” and filed Jun. 1, 2022, which is assigned to the assignee hereof and expressly incorporated by reference herein.

### FIELD OF TECHNOLOGY

The present disclosure relates generally to data management, and more specifically to archiving computing snapshots to multiple locations in accordance with a service level agreement.

### BACKGROUND

A data management system (DMS) may be employed to manage data associated with one or more computing systems. The data may be generated, stored, or otherwise used by the one or more computing systems, examples of which may include servers, databases, virtual machines, cloud computing systems, file systems (e.g., network-attached storage (NAS) systems), or other data storage or processing systems. The DMS may provide data backup, data recovery, data classification, or other types of data management services for data of the one or more computing systems. Improved data management may offer improved performance with respect to reliability, speed, efficiency, scalability, security, or ease-of-use, among other possible aspects of performance.

### BRIEF DESCRIPTION OF THE DRAWINGS

FIG. 1 illustrates an example of a computing environment that supports archiving computing snapshots to multiple locations in accordance with a service level agreement (SLA) in accordance with aspects of the present disclosure.

FIG. 2 illustrates an example of a process flow that supports archiving computing snapshots to multiple locations in accordance with an SLA in accordance with aspects of the present disclosure.

FIG. 3 illustrates an example of a process flow that supports archiving computing snapshots to multiple locations in accordance with an SLA in accordance with aspects of the present disclosure.

FIG. 4 illustrates an example of a process flow that supports archiving computing snapshots to multiple locations in accordance with an SLA in accordance with aspects of the present disclosure.

FIG. 5 illustrates an example of a process flow that supports archiving computing snapshots to multiple locations in accordance with an SLA in accordance with aspects of the present disclosure.

FIG. 6 illustrates an example of a process flow that supports archiving computing snapshots to multiple locations in accordance with an SLA in accordance with aspects of the present disclosure.

FIG. 7 shows a block diagram of an apparatus that supports archiving computing snapshots to multiple locations in accordance with an SLA in accordance with aspects of the present disclosure.

FIG. 8 shows a block diagram of a storage manager that supports archiving computing snapshots to multiple locations in accordance with an SLA in accordance with aspects of the present disclosure.

FIG. 9 shows a diagram of a system including a device that supports archiving computing snapshots to multiple locations in accordance with an SLA in accordance with aspects of the present disclosure.

FIGS. 10 through 14 show flowcharts illustrating methods that support archiving computing snapshots to multiple locations in accordance with an SLA in accordance with aspects of the present disclosure.

### DETAILED DESCRIPTION

A data management system (DMS) may take snapshots of a computing object (e.g., a customer data source) at different frequencies and for different purposes. For example, snapshots may be used for disaster recovery purposes (e.g., for data recovery) or long-term retention purposes (e.g., for compliance purposes). Snapshots may be retained for different retention periods based on the snapshot frequency and purpose. For example, a given service level agreement (SLA) may specify that daily snapshots may be retained for 30 days, weekly snapshots may be retained for 24 weeks, monthly snapshots may be retained for 12 months, and quarterly snapshots may be retained for 7 years. Because of factors such as cost or latency, a customer may prefer different archive locations for different snapshot purposes. An archive location may be, for example an external cloud storage environment or an on-premises (e.g., customer premises) data store. For example, a customer may prefer a snapshot for data recovery purposes be stored in an archive location that can be quickly accessed in order to minimize downtime in the event of a system failure and backup recovery (e.g., an on-premises data store), whereas a customer may prefer a snapshot for long-term retention compliance purposes be stored in an increased-latency but lower-cost archive location (e.g., a cloud storage environment). In some data management systems, snapshots associated with a single SLA may not be stored in (e.g., routed and transmitted to) different archival targets, and a single archival target may not support different retention thresholds. Accordingly, in such data management systems, daily and weekly snapshots, if archived, may be archived for the same duration as quarterly snapshots, and disaster recovery snapshots may be archived in the same archive storage as long-term retention snapshots, which may impact data storage costs or recovery times for customers.

Aspects of the present disclosure relate to the use of multiple archive locations, including potentially within a same SLA domain (e.g., in accordance with a single SLA). When a snapshot of a data source (e.g., a customer's data) is captured, the DMS may identify one or more target archive locations for the snapshot based on the frequency of the snapshot (e.g., daily, weekly, monthly, quarterly) and the associated retention policy (e.g., the purpose of the snapshot). For example, a snapshot for long-term retention purposes may be transmitted to one archive location and a snapshot for disaster recovery may be transmitted to a different archive location. In some cases, the archive location(s) to which each snapshot is transmitted may be determined based on the frequency associated with the snapshots. A user (e.g., customer) may select a retention duration independent of when or where the snapshot is archived. Accordingly, daily snapshots may be retained in an archive for a shorter duration than weekly snapshots, which may be retained in the archive for a shorter duration than monthly snapshots, etc. Additionally, the same snapshot may be used for multiple purposes and may be associated with different frequencies. For example, a given snapshot may be both a daily and monthly snapshot (e.g., if weekly snapshots are taken on Fridays). The same snapshot may be used for both long-term retention purposes and disaster recovery purposes. For example, daily snapshots taken on all days of the week except for Fridays may be used for long-term retention purposes, and daily snapshots taken on Fridays may be used for both long-term retention purposes and disaster recovery purposes. Accordingly, the same snapshot may be transmitted to more than one archive location and retained in each archive for a selectable duration. Customers may also have the ability to download or restore a copy of a given snapshot from a specific archive location.

An SLA definition for a data source may provide the snapshot frequencies and archival policies. The snapshot frequencies may specify when to capture snapshots and how long to retain the snapshots and the archival policies may specify which frequency snapshots to archive, the corresponding archive location, and when to archive the snapshots. A backup job may capture snapshots as defined by the SLA and tag the snapshots with applicable frequencies. A periodically running archival job may evaluate the captured snapshots against the defined archival policy and transmit the snapshots to the applicable archive locations. A periodically running expiration job may evaluate archived snapshots per the snapshot frequency, age and archival policies and may remove expired snapshots. In the case that multiple snapshots are archived (e.g., based on different snapshot purposes), a customer may select which archive location to download a copy from for recovery purposes, thereby enabling a customer to optimize performance and cost.

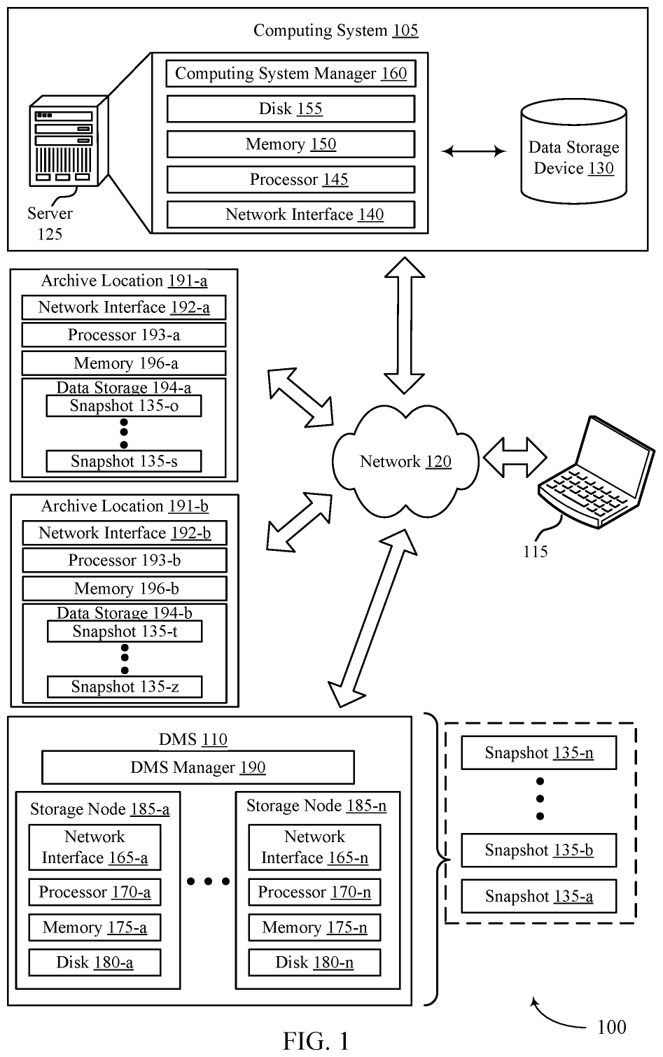

FIG. 1 illustrates an example of a computing environment 100 that supports archiving computing snapshots to multiple locations in accordance with an SLA in accordance with aspects of the present disclosure. The computing environment 100 may include a computing system 105, a DMS 110, and one or more computing devices 115, which may be in communication with one another via a network 120. The computing system 105 may generate, store, process, modify, or otherwise use associated data, and the DMS 110 may provide one or more data management services for the computing system 105. For example, the DMS 110 may provide a data backup service, a data recovery service, a data classification service, a data transfer or replication service (e.g., data transfer to one or more archive locations 191), one or more other data management services, or any combination thereof for data associated with the computing system 105.

The network 120 may allow the one or more computing devices 115, the computing system 105, the archive location(s) 191 and the DMS 110 to communicate (e.g., exchange information) with one another. The network 120 may include aspects of one or more wired networks (e.g., the Internet), one or more wireless networks (e.g., cellular networks), or any combination thereof. The network 120 may include aspects of one or more public networks or private networks, as well as secured or unsecured networks, or any combination thereof. The network 120 also may include any quantity of communications links and any quantity of hubs, bridges, routers, switches, ports or other physical or logical network components.

A computing device 115 may be used to input information to or receive information from the computing system 105, the DMS 110, or both. For example, a user of the computing device 115 may provide user inputs via the computing device 115, which may result in commands, data, or any combination thereof being communicated via the network 120 to the computing system 105, the DMS 110, or both. Additionally, or alternatively, a computing device 115 may output (e.g., display) data or other information received from the computing system 105, the DMS 110, or both. A user of a computing device 115 may, for example, use the computing device 115 to interact with one or more user interfaces (e.g., graphical user interfaces (GUIs)) to operate or otherwise interact with the computing system 105, the DMS 110, or both. Though one computing device 115 is shown in FIG. 1, it is to be understood that the computing environment 100 may include any quantity of computing devices 115.

A computing device 115 may be a stationary device (e.g., a desktop computer or access point) or a mobile device (e.g., a laptop computer, tablet computer, or cellular phone). In some examples, a computing device 115 may be a commercial computing device, such as a server or collection of servers. And in some examples, a computing device 115 may be a virtual device (e.g., a virtual machine). Though shown as a separate device in the example computing environment of FIG. 1, it is to be understood that in some cases a computing device 115 may be included in (e.g., may be a component of) the computing system 105 or the DMS 110.

The computing system 105 may include one or more servers 125 and may provide (e.g., to the one or more computing devices 115) local or remote access to applications, databases, or files stored within the computing system 105. The computing system 105 may further include one or more data storage devices 130. Though one server 125 and one data storage device 130 are shown in FIG. 1, it is to be understood that the computing system 105 may include any quantity of servers 125 and any quantity of data storage devices 130, which may be in communication with one another and collectively perform one or more functions ascribed herein to the server 125 and data storage device 130.

A data storage device 130 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 130 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 130 may be a database (e.g., a relational database), and a server 125 may host (e.g., provide a database management system for) the database.

A server 125 may allow a client (e.g., a computing device 115) to download information or files (e.g., executable, text, application, audio, image, or video files) from the computing system 105, to upload such information or files to the computing system 105, or to perform a search query related to particular information stored by the computing system 105. In some examples, a server 125 may act as an application server or a file server. In general, a server 125 may refer to one or more hardware devices that act as the host in a client-server relationship or a software process that shares a resource with or performs work for one or more clients.

A server 125 may include a network interface 140, processor 145, memory 150, disk 155, and computing system manager 160. The network interface 140 may enable the server 125 to connect to and exchange information via the network 120 (e.g., using one or more network protocols). The network interface 140 may include one or more wireless network interfaces, one or more wired network interfaces, or any combination thereof. The processor 145 may execute computer-readable instructions stored in the memory 150 in order to cause the server 125 to perform functions ascribed herein to the server 125. The processor 145 may include one or more processing units, such as one or more central processing units (CPUs), one or more graphics processing units (GPUs), or any combination thereof. The memory 150 may comprise one or more types of memory (e.g., random access memory (RAM), static random access memory (SRAM), dynamic random access memory (DRAM), read-only memory (ROM), electrically erasable programmable read-only memory (EEPROM), Flash, etc.). Disk 155 may include one or more HDDs, one or more SSDs, or any combination thereof. Memory 150 and disk 155 may comprise hardware storage devices. The computing system manager 160 may manage the computing system 105 or aspects thereof (e.g., based on instructions stored in the memory 150 and executed by the processor 145) to perform functions ascribed herein to the computing system 105. In some examples, the network interface 140, processor 145, memory 150, and disk 155 may be included in a hardware layer of a server 125, and the computing system manager 160 may be included in a software layer of the server 125. In some cases, the computing system manager 160 may be distributed across (e.g., implemented by) multiple servers 125 within the computing system 105.

In some examples, the computing system 105 or aspects thereof may be implemented within one or more cloud computing environments, which may alternatively be referred to as cloud environments. Cloud computing may refer to Internet-based computing, wherein shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the computing system 105 or aspects thereof through Software-as-a-Service (SaaS) or Infrastructure-as-a-Service (IaaS) services provided by the cloud environment. SaaS may refer to a software distribution model in which applications are hosted by a service provider and made available to one or more client devices over a network (e.g., to one or more computing devices 115 over the network 120). IaaS may refer to a service in which physical computing resources are used to instantiate one or more virtual machines, the resources of which are made available to one or more client devices over a network (e.g., to one or more computing devices 115 over the network 120).

In some examples, the computing system 105 or aspects thereof may implement or be implemented by one or more virtual machines. The one or more virtual machines may run various applications, such as a database server, an application server, or a web server. For example, a server 125 may be used to host (e.g., create, manage) one or more virtual machines, and the computing system manager 160 may manage a virtualized infrastructure within the computing system 105 and perform management operations associated with the virtualized infrastructure. The computing system manager 160 may manage the provisioning of virtual machines running within the virtualized infrastructure and provide an interface to a computing device 115 interacting with the virtualized infrastructure. For example, the computing system manager 160 may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk 155, the memory, the processor 145, the network interface 140, the data storage device 130, or any combination thereof in support of running the various applications. Storage resources (e.g., the disk 155, the memory 150, or the data storage device 130) that are virtualized may be accessed by applications as a virtual disk.

The DMS 110 may provide one or more data management services for data associated with the computing system 105 and may include DMS manager 190 and any quantity of storage nodes 185. The DMS manager 190 may manage operation of the DMS 110, including the storage nodes 185. Though illustrated as a separate entity within the DMS 110, the DMS manager 190 may in some cases be implemented (e.g., as a software application) by one or more of the storage nodes 185. In some examples, the storage nodes 185 may be included in a hardware layer of the DMS 110, and the DMS manager 190 may be included in a software layer of the DMS 110. In the example illustrated in FIG. 1, the DMS 110 is separate from the computing system 105 but in communication with the computing system 105 via the network 120. It is to be understood, however, that in some examples at least some aspects of the DMS 110 may be located within computing system 105. For example, one or more servers 125, one or more data storage devices 130, and at least some aspects of the DMS 110 may be implemented within the same cloud environment or within the same data center.

Storage nodes 185 of the DMS 110 may include respective network interfaces 165, processors 170, memories 175, and disks 180. The network interfaces 165 may enable the storage nodes 185 to connect to one another, to the network 120, or both. A network interface 165 may include one or more wireless network interfaces, one or more wired network interfaces, or any combination thereof. The processor 170 of a storage node 185 may execute computer-readable instructions stored in the memory 175 of the storage node 185 in order to cause the storage node 185 to perform processes described herein as performed by the storage node 185. A processor 170 may include one or more processing units, such as one or more CPUs, one or more GPUs, or any combination thereof. The memory 150 may comprise one or more types of memory (e.g., RAM, SRAM, DRAM, ROM, EEPROM, Flash, etc.). A disk 180 may include one or more HDDs, one or more SDDs, or any combination thereof. Memories 175 and disks 180 may comprise hardware storage devices. Collectively, the storage nodes 185 may in some cases be referred to as a storage cluster or as a cluster of storage nodes 185.

The DMS 110 may provide a backup and recovery service for the computing system 105. For example, the DMS 110 may manage the extraction and storage of snapshots 135 associated with different point-in-time versions of one or more target computing objects within the computing system 105. A snapshot 135 of a computing object (e.g., a virtual machine, a database, a filesystem, a virtual disk, a virtual desktop, or other type of computing system or storage system) may be a file (or set of files) that represents a state of the computing object (e.g., the data thereof) as of a particular point in time. A snapshot 135 may also be used to restore (e.g., recover) the corresponding computing object as of the particular point in time corresponding to the snapshot 135. A computing object of which a snapshot 135 may be generated may be referred to as snappable. Snapshots 135 may be generated at different times (e.g., periodically or on some other scheduled or configured basis) in order to represent the state of the computing system 105 or aspects thereof as of those different times. In some examples, a snapshot 135 may include metadata that defines a state of the computing object as of a particular point in time. For example, a snapshot 135 may include metadata associated with (e.g., that defines a state of) some or all data blocks included in (e.g., stored by or otherwise included in) the computing object. Snapshots 135 (e.g., collectively) may capture changes in the data blocks over time. Snapshots 135 generated for the target computing objects within the computing system 105 may be stored in one or more storage locations (e.g., the disk 155, memory 150, the data storage device 130) of the computing system 105, in the alternative or in addition to being stored within the DMS 110, as described below.

To obtain a snapshot 135 of a target computing object associated with the computing system 105 (e.g., of the entirety of the computing system 105 or some portion thereof, such as one or more databases, virtual machines, or filesystems within the computing system 105), the DMS manager 190 may transmit a snapshot request to the computing system manager 160. In response to the snapshot request, the computing system manager 160 may set the target computing object into a frozen state (e.g., a read-only state). Setting the target computing object into a frozen state may allow a point-in-time snapshot 135 of the target computing object to be stored or transferred.

In some examples, the computing system 105 may generate the snapshot 135 based on the frozen state of the computing object. For example, the computing system 105 may execute an agent of the DMS 110 (e.g., the agent may be software installed at and executed by one or more servers 125), and the agent may cause the computing system 105 to generate the snapshot 135 and transfer the snapshot to the DMS 110 in response to the request from the DMS 110. In some examples, the computing system manager 160 may cause the computing system 105 to transfer, to the DMS 110, data that represents the frozen state of the target computing object, and the DMS 110 may generate a snapshot 135 of the target computing object based on the corresponding data received from the computing system 105.

Once the DMS 110 receives, generates, or otherwise obtains a snapshot 135, the DMS 110 may store the snapshot 135 at one or more of the storage nodes 185. The DMS 110 may store a snapshot 135 at multiple storage nodes 185, for example, for improved reliability. Additionally, or alternatively, snapshots 135 may be stored in some other location connected with the network 120. For example, the DMS 110 may store more recent snapshots 135 (e.g., a snapshot 135-a, a snapshot 135-b, . . . , a snapshot 135-n) at the storage nodes 185, and the DMS 110 may transfer less recent snapshots 135 via the network 120 to one or more archive locations 191 for storage at the one or more archive locations 191. An archive locations 191 may be a cloud environment (which may include or be separate from the computing system 105), a magnetic tape storage device, or another storage system separate from the DMS 110.

Updates made to a target computing object that has been set into a frozen state may be written by the computing system 105 to a separate file (e.g., an update file) or other entity within the computing system 105 while the target computing object is in the frozen state. After the snapshot 135 (or associated data) of the target computing object has been transferred to the DMS 110, the computing system manager 160 may release the target computing object from the frozen state, and any corresponding updates written to the separate file or other entity may be merged into the target computing object.

In response to a restore command (e.g., from a computing device 115 or the computing system 105), the DMS 110 may restore a target version (e.g., corresponding to a particular point in time) of a computing object based on a corresponding snapshot 135 of the computing object. In some examples, the corresponding snapshot 135 may be used to restore the target version based on data of the computing object as stored at the computing system 105 (e.g., based on information included in the corresponding snapshot 135 and other information stored at the computing system 105, the computing object may be restored to its state as of the particular point in time). Additionally, or alternatively, the corresponding snapshot 135 may be used to restore the data of the target version based on data of the computing object as included in one or more backup copies of the computing object (e.g., file-level backup copies or image-level backup copies). Such backup copies of the computing object may be generated in conjunction with or according to a separate schedule than the snapshots 135. For example, the target version of the computing object may be restored based on the information in a snapshot 135 and based on information included in a backup copy of the target object generated prior to the time corresponding to the target version. Backup copies of the computing object may be stored at the DMS 110 (e.g., in the storage nodes 185) or in some other archive location 191 connected with the network 120 (e.g., in a cloud environment, which in some cases may be separate from the computing system 105). As described herein, locations where snapshots 135 are stored may be defined in an SLA.

In some examples, the DMS 110 may restore the target version of the computing object and transfer the data of the restored computing object to the computing system 105. And in some examples, the DMS 110 may transfer one or more snapshots 135 to the computing system 105, and restoration of the target version of the computing object may occur at the computing system 105 (e.g., as managed by an agent of the DMS 110, where the agent may be installed and operate at the computing system 105).

In response to a mount command (e.g., from a computing device 115 or the computing system 105), the DMS 110 may instantiate data associated with a point-in-time version of a computing object based on a snapshot 135 corresponding to the computing object (e.g., along with data included in a backup copy of the computing object) and the point-in-time. The DMS 110 may then allow the computing system 105 to read or modify the instantiated data (e.g., without transferring the instantiated data to the computing system). In some examples, the DMS 110 may instantiate (e.g., virtually mount) some or all of the data associated with the point-in-time version of the computing object for access by the computing system 105, the DMS 110, or the computing device 115.

In some examples, the DMS 110 may store different types of snapshots, including for the same computing object. For example, the DMS 110 may store both base snapshots 135 and incremental snapshots 135. A base snapshot 135 may represent the entirety of the state of the corresponding computing object as of a point in time corresponding to the base snapshot 135. An incremental snapshot 135 may represent the changes to the state—which may be referred to as the delta—of the corresponding computing object that have occurred between an earlier or later point in time corresponding to another snapshot 135 (e.g., another base snapshot 135 or incremental snapshot 135) of the computing object and the incremental snapshot 135. In some cases, some incremental snapshots 135 may be forward-incremental snapshots 135 and other incremental snapshots 135 may be reverse-incremental snapshots 135. To generate a full snapshot 135 of a computing object using a forward-incremental snapshot 135, the information of the forward-incremental snapshot 135 may be combined with (e.g., applied to) the information of an earlier base snapshot 135 of the computing object along with the information of any intervening forward-incremental snapshots 135, where the earlier base snapshot 135 may include a base snapshot 135 and one or more reverse-incremental or forward-incremental snapshots 135. To generate a full snapshot 135 of a computing object using a reverse-incremental snapshot 135, the information of the reverse-incremental snapshot 135 may be combined with (e.g., applied to) the information of a later base snapshot 135 of the computing object along with the information of any intervening reverse-incremental snapshots 135.

In some examples, the DMS 110 may provide a data classification service, a malware detection service, a data transfer or replication service, backup verification service, or any combination thereof, among other possible data management services for data associated with the computing system 105. For example, the DMS 110 may analyze data included in one or more computing objects of the computing system 105, metadata for one or more computing objects of the computing system 105, or any combination thereof, and based on such analysis, the DMS 110 may identify locations within the computing system 105 that include data of one or more target data types (e.g., sensitive data, such as data subject to privacy regulations or otherwise of particular interest) and output related information (e.g., for display to a user via a computing device 115). Additionally, or alternatively, the DMS 110 may detect whether aspects of the computing system 105 have been impacted by malware (e.g., ransomware). Additionally, or alternatively, the DMS 110 may relocate data or create copies of data based on using one or more snapshots 135 to restore the associated computing object within its original location or at a new location (e.g., a new location within a different computing system 105). Additionally, or alternatively, the DMS 110 may analyze backup data to ensure that the underlying data (e.g., user data or metadata) has not been corrupted. The DMS 110 may perform such data classification, malware detection, data transfer or replication, or backup verification, for example, based on data included in snapshots 135 or backup copies of the computing system 105, rather than live contents of the computing system 105, which may beneficially avoid adversely.

As described herein, the snapshots 135 of one or more target computing objects within the computing system 105 may be taken at different frequencies and for different purposes in accordance with an SLA for the target computing object of the computing system 105. For example, a customer may define, frequencies, archival policies (e.g., based on purposed for the snapshots), storage locations, and retention periods for snapshots 135 of a target computing object within the computing system 105. For example, a given SLA may specify that daily snapshots 135 may be retained for 30 days, weekly snapshots may be retained for 24 weeks, monthly snapshots may be retained for 12 months, and quarterly snapshots may be retained for 7 years. Because of factors such as cost or latency, a customer may prefer different archive locations 191 for different snapshot purposes.

An archive location 191 (e.g., a first archive location 191-a) may be, for example, a cloud environment (which may include or be separate from the computing system 105), a magnetic tape storage device, or another storage system separate from the DMS 110. In some cases, to decrease latency, an archive location may be located on customer premises (e.g., at the computing system 105).

A first archive location 191-a may include a network interface 192-a which may enable to archive location to connect to and exchange information via the network 120 (e.g., using one or more network protocols). The network interface 192-a may include one or more wireless network interfaces, one or more wired network interfaces, or any combination thereof. The first archive location 191-a may include a processor 193-a and a memory 196-a. The processor 193-a may execute computer-readable instructions stored in the memory 196-a in order to cause the first archive location 191-a to perform functions ascribed herein. The processor 193-a may include one or more processing units, such as one or more CPUs, one or more GPUs, or any combination thereof. The memory 196-a may comprise one or more types of memory (e.g., RAM, SRAM, DRAM, ROM, EEPROM, Flash, etc.). The first archive location 191-a may include a data storage device 194-a. The data storage device 194-a may include one or more hardware storage devices operable to store data, such as one or more HDDs, magnetic tape drives, SSDs, SAN storage devices, or NAS devices. In some cases, the data storage device 194-a may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 130 may be a database (e.g., a relational database), and a server may host (e.g., provide a database management system for) the database. In some cases, the first archive location 191-a may be distributed across (e.g., implemented by) multiple servers or computing devices.

A second archive location 191-b may include a network interface 192-b which may enable to archive location to connect to and exchange information via the network 120 (e.g., using one or more network protocols). The network interface 192-b may include one or more wireless network interfaces, one or more wired network interfaces, or any combination thereof. The second archive location 191-b may include a processor 193-b and a memory 196-b. The processor 193-b may execute computer-readable instructions stored in the memory 196-b in order to cause the second archive location 191-b to perform functions ascribed herein. The processor 193-b may include one or more processing units, such as one or more CPUs, one or more GPUs, or any combination thereof. The memory 196-b may comprise one or more types of memory (e.g., RAM, SRAM, DRAM, ROM, EEPROM, Flash, etc.). The second archive location 191-b may include a data storage device 194-b. The data storage device 194-b may include one or more hardware storage devices operable to store data, such as one or more HDDs, magnetic tape drives, SSDs, SAN storage devices, or NAS devices. In some cases, the data storage device 194-b may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 130 may be a database (e.g., a relational database), and a server may host (e.g., provide a database management system for) the database. In some cases, the second archive location 191-b may be distributed across (e.g., implemented by) multiple servers or computing devices.

A customer may prefer a snapshot 135 for data recovery purposes be stored in an archive location 191 that may be quickly accessed in order to minimize downtime in the event of a system failure and backup recovery (e.g., an on-premises data store), whereas a customer may prefer a snapshot 135 for long-term retention compliance purposes be stored in an increased-latency but lower-cost archive location (e.g., a cloud storage environment). For example, the first archive location 191-a may be associated with less latency (and higher cost) as compared to the second archive location 191-b.

When a snapshot 135 of a data source is captured according to an SLA, the DMS 110 may identify one or more target archive locations 191 for the snapshot based on the frequency of the snapshot 135 (e.g., daily, weekly, monthly, quarterly) and the associated archival policy (e.g., the purpose of the snapshot 135). For example, a snapshot 135 for long-term retention purposes may be transmitted to one archive location (e.g., the second archive location 191-b) and a snapshot 135 for disaster recovery may be transmitted to a different archive location (e.g., the first archive location 191-a). For example, the first archive location 191-a may be associated with less latency and may therefore enable faster recovery, while the second archive location may be associated with lower costs. For example, a snapshot 135-o, . . . , and a snapshot 135-s may be stored in the data storage device 194-a of the first archive location 191-a, and a snapshot 135-t, . . . , and a snapshot 135-z may be stored in the data storage device 194-b of the second archive location 191-b.

A user (e.g., customer) may select a retention duration for different types of snapshots 135 independent of when or where the snapshot 135 is archived. For example, an SLA may specify the retention duration independent of the archive location 191. According to an SLA, some snapshots 135 may not be transmitted to an archive location 191, and may be stored at the DMS (e.g., in storage nodes 185). In some cases, daily snapshots 135 (e.g., snapshots 135 of a target object of the computing system 105 that are captured daily according to an SLA) may be retained in an archive for a shorter duration than weekly snapshots 135 (e.g., snapshots 135 of a target object of the computing system 105 that are captured weekly according to an SLA), which may be retained in the archive for a shorter duration than monthly snapshots 135 (e.g., snapshots 135 of a target object of the computing system 105 that are captured monthly according to an SLA), etc. Additionally, the same snapshot 135 may be used for multiple purposes and may be associated with different frequencies. For example, a given snapshot may be both a daily and monthly snapshot (e.g., if weekly snapshots are taken on Fridays). The same snapshot 135 may be used for both long-term retention purposes and disaster recovery purposes. For example, daily snapshots 135 taken on all days of the week except for Fridays may be used for long-term retention purposes, and daily snapshots taken on Fridays may be used for both long-term retention purposes and disaster recovery purposes. Accordingly, the same snapshot may be transmitted to more than one archive location 191 and retained in each archive for a selectable duration. Customers may also have the ability to download or restore a copy of a given snapshot from a specific archive location.

An SLA definition for a data source may provide the snapshot frequencies and archival policies. The snapshot frequencies may specify when to capture snapshots 135 for a target computing object of the computing system 105 and how long to retain the snapshots 135. The archival policies may specify which frequency snapshots 135 to transmit to an archive location (if at all) and/or when to transmit the snapshots 135 to an archive location. For example, snapshots 135 taken at a first frequency (e.g., daily) may be stored at the DMS 110 (e.g., in storage nodes 185) and snapshots 135 taken at another frequency (e.g., weekly) may be stored in an archive location 191 (or multiple archive locations 191). The archival policies may specify an archive location. For example, the SLA may specify that daily snapshots 135 are for long-term retention purposes, and accordingly may be stored in the first archive location 191-a. The SLA may specify that daily snapshots taken on Fridays are also used for disaster recovery, and therefore daily snapshots 135 taken on Fridays may be stored in both the first archive location 191-a and the second archive location 191-b. The archival policies may also specify when to transmit snapshots to the respective archive locations 191. For example, snapshots 135 may be stored at the DMS 110 (e.g., in storage nodes 185) for a specified retention period until the snapshots 135 have been transmitted to an identified archive location 191.

The DMS may generate a backup job that may capture snapshots 135 as defined by the SLA. The backup job may tag the snapshots 135 with applicable frequency and archival policy parameters in accordance with an SLA definition. For example, a daily snapshot 135 may be tagged with a daily frequency parameter, a weekly snapshot 135 may be tagged with a weekly parameter, etc. In some cases, the same snapshot 135 may be tagged with multiple frequency parameters. For example, the SLA definition may specify that the Friday daily snapshot 135 is also the weekly snapshot 135, so the Friday snapshot 135 may be tagged with both a weekly parameter and a daily parameter. Archival policy parameters may specify which frequency snapshots to archive, the corresponding archive location, and when to archive the snapshots. For example, an SLA definition may specify to archive weekly snapshots to one archive location 191 (e.g., a disaster recovery archive location), monthly snapshots to another archive location 191 (e.g., a long-term retention archive location), and not to archive daily snapshots. In some cases, the SLA definition may specify to archive some daily snapshots 135 (e.g., taken Monday, Wednesday, and Friday) and not to archive other daily snapshots 135 (e.g., Tuesday, Thursday, Saturday, and Sunday). Accordingly, as described herein, the frequency parameter may specify the frequency at which a particular snapshot 135 was taken, as specified by an SLA definition, and the archival policy parameters may specify whether, where, and when to archive a particular snapshot 135 in as specified by the SLA definition. For example, the SLA definition may provide a purpose (e.g., for disaster recovery or long-term retention for compliance purposes) for each snapshot 135, and some snapshots 135 may be associated with multiple purposes. The archival policy parameters may include or be based on the purpose for each snapshot 135. For example, a snapshot 135 may be tagged with a long-term retention parameter and/or a disaster recovery parameter based on the purpose of the given snapshot 135. Snapshots 135 tagged with a long-term retention parameter may be associated with and transmitted to the second archive location 191-b and snapshots 135 tagged with a disaster recovery parameter may be associated with and transmitted to the first archive location 191-a.

For example, the backup job may cause the computing system 105 to execute an agent of the DMS 110 (e.g., the agent may be software installed at and executed by one or more servers 125), and the agent may cause the computing system 105 to generate the snapshot 135 and transfer the snapshot to the DMS 110 in response to the request from the backup job generated by the DMS 110. The backup job may tag the snapshots 135 with applicable frequency and/or archival policy parameters in accordance with an SLA definition. The backup job may store the tagged snapshots 135 in storage nodes 185 of the DMS 110. In some cases, the backup job may not tag the snapshots 135 with applicable frequency and/or archival policy parameters, and the DMS 110 may tag the snapshots 135 with applicable frequency and/or archival policy parameters at a later time (e.g., once the snapshots 135 are stored in storage nodes 185 of the DMS 110).

The DMS 110 may periodically generate and run an archival job. The archival job may evaluate the snapshots 135 stored in the storage nodes 185 against the archival policies of the SLA and transmit the snapshots to the applicable archive locations 191 based on the archival policy.

The DMS 110 may periodically generate and run an expiration job. The expiration job may evaluate snapshots 135 transmitted to archive locations 191 per each snapshot's frequency, age and archival policies and may remove expired snapshots 135. For example, the expiration job may transmit an indication to the respective archive locations to delete the identified expired snapshots 135. The expiration job may also remove snapshots 135 from the storage nodes 185 which have been transmitted to one or more archive locations 191 or which have expired. A snapshot 135 may be expired if the snapshot has surpassed a retention duration specified by the SLA. For example, a snapshot 135 may be tagged with a timestamp of when the snapshot was captured. If the duration since the timestamp exceeds the retention period defined in the SLA for a snapshot having the frequency parameter of the snapshot 135, the expiration job may determine that the snapshot 135 is expired.

In some cases, when a particular snapshot 135 is stored in multiple archive locations 191 (e.g., based on different purposes for the particular snapshot), a user may select which archive location 191 to download a copy from (e.g., for recovery purposes, compliance purposes, or other purposes), thereby enabling a customer to optimize performance and cost. For example, a user at a computing device 115 may request to retrieve a particular snapshot 135 taken at a particular time or date. The DMS 110 may identify each archive location 191 at which the requested snapshot 135 is stored. The DMS 110 may provide an indication of the archive locations 191 at which the requested snapshot 135 is stored to the computing device 115, and the computing device may present a listing of the archive locations 191. The computing device 115 may receive a selection (e.g., from a user) of an archive location 191 from the listing of the archive locations 191, and the computing device may transmit an indication of the selected archive location to the DMS 110. The DMS 110 may retrieve the snapshot 135 from the selected archive location. The DMS 110 may then use the retrieved snapshot 135 for recovery purposes, compliance purposes, or other purposes.

In some cases, when a particular snapshot 135 is stored in multiple archive locations 191 (e.g., based on different purposes for the particular snapshot), a user may specify a retrieval purpose in a retrieval request. For example, a user at a computing device 115 may request to retrieve a particular snapshot 135 taken at a particular time or date, and the request may specify a retrieval purpose (e.g., for disaster recovery, compliance, or other purpose). The DMS 110 may identify each archive location 191 at which the requested snapshot 135 is stored and may identify an optimal archive location 191 based on the indicated purpose for the retrieval. The DMS 110 may retrieve the requested snapshot 135 from the identified archive location. For example, for disaster recovery purposes, the DMS may recover the snapshot from a lower latency archive location 191 in order to optimize recovery time.

In some cases, a DMS 110 that manages snapshots for a target computing object of the computing system 105 according to an SLA may be unavailable (e.g., the DMS 110 may fail, lose power, lose network connectivity, or otherwise be inaccessible by other components of the computing environment 100). A second DMS 110 for the target computing object of the computing system 105 in accordance with the SLA may be generated. The second DMS 110 may identify the archived locations of the snapshots associated with the SLA and may recover snapshots 135 similarly to the first DMS 110.

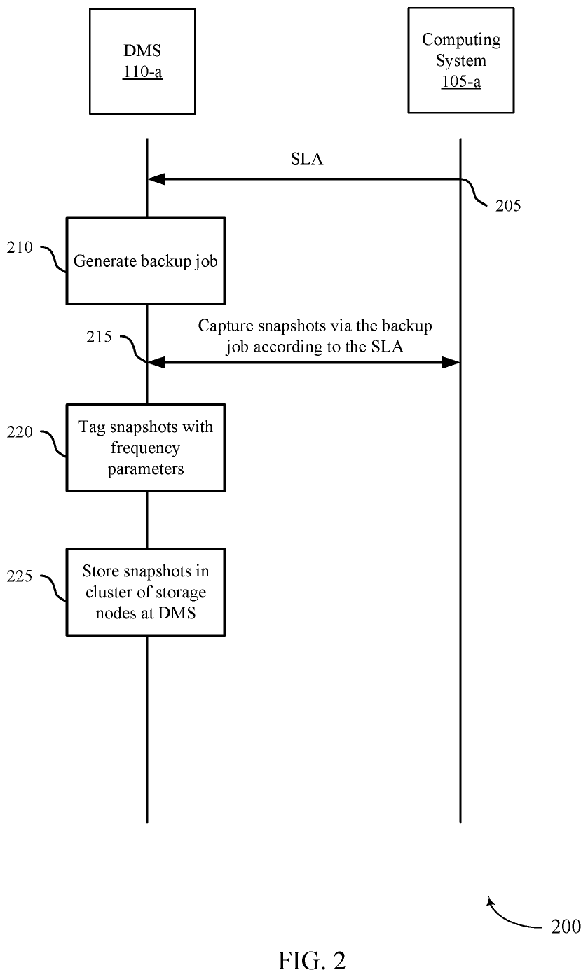

FIG. 2 illustrates an example of a process flow 200 that supports archiving computing snapshots to multiple locations in accordance with an SLA in accordance with aspects of the present disclosure. The process flow 200 may include a DMS 110-a, which may be an example of a DMS 110 as described herein. The process flow 200 may include a computing system 105-a, which may be an example of a computing system 105 as described herein. In the following description of the process flow 200, the operations between the DMS 110-a and the computing system 105-a may be transmitted in a different order than the example order shown, or the operations performed by the DMS 110-a and the computing system 105-a may be performed in different orders or at different times. Some operations may also be omitted from the process flow 200, and other operations may be added to the process flow 200.

At 205, the DMS 110-a may receive an indication of an SLA for a target computing object of the computing system 105-a. The SLA may define frequencies at which to take snapshots of the target computing object of the computing system 105-a and archival policies for given snapshots. For example, the SLA may define which snapshots should be tagged with which frequency and/or archival policy parameters.

At 210, the DMS 110-a may generate a backup job. At 215, the backup job may capture snapshots of the target computing object of the computing system 105-a according to the SLA. For example, the SLA may specify to take daily snapshots, weekly snapshots, monthly snapshots, quarterly snapshots, etc.

At 220, the backup job may tag the captured snapshots with frequency parameters in accordance with the SLA.

At 225, the backup job may store the captured snapshots with the respective frequency parameters in a cluster of storage nodes at the DMS 110-a.

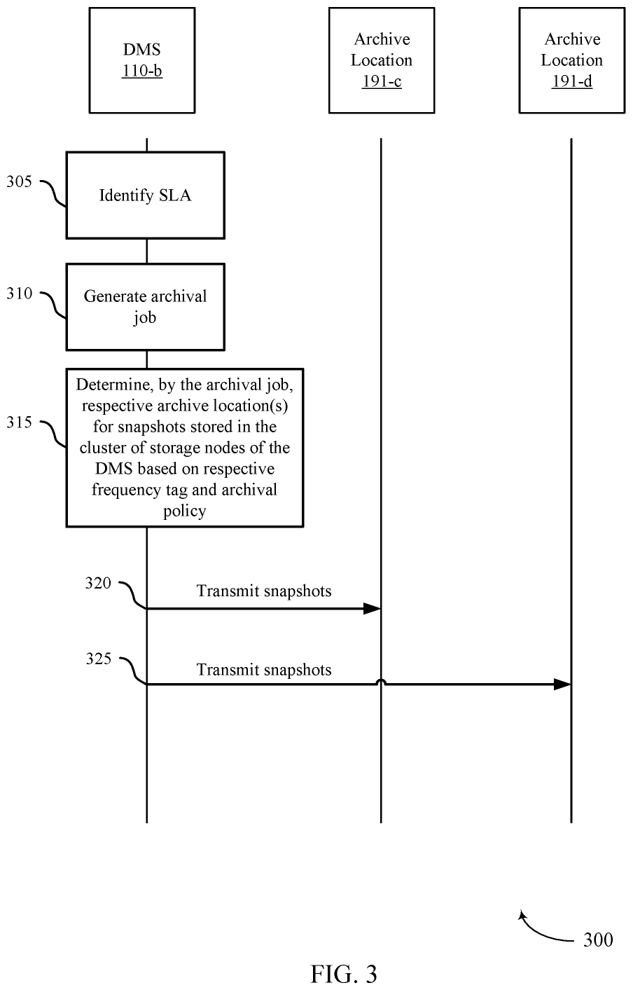

FIG. 3 illustrates an example of a process flow 300 that supports archiving computing snapshots to multiple locations in accordance with an SLA in accordance with aspects of the present disclosure. The process flow 300 may include a DMS 110-b, which may be an example of a DMS 110 as described herein. The process flow 300 may include a first archive location 191-c and a second archive location 191-d, which may be an example of a computing system 105 as described herein. In the following description of the process flow 300, the operations between the DMS 110-b, the first archive location 191-c, and the second archive location 191-d may be transmitted in a different order than the example order shown, or the operations performed by the DMS 110-b, the first archive location 191-c, and the second archive location 191-d may be performed in different orders or at different times. Some operations may also be omitted from the process flow 300, and other operations may be added to the process flow 300.

At 305, the DMS 110-b may identify an SLA for a target computing object of the computing system.

At 310, the DMS 110-b may generate an archival job for snapshots of the target computing object of the computing system associated with the SLA. For example, the DMS 110-b may generate the archival job periodically (e.g., daily, weekly etc.)

At 315, the archival job may determine, for each of the snapshots of the target computing object of the computing system stored in the cluster of storage nodes at the DMS 110-b, one or more respective archive locations based on the frequency parameter tagged with each snapshot and the archival policy defined by the SLA. The archival job may work through snapshots stored on the cluster of storage nodes chronologically (e.g., from oldest snapshot to newest snapshot). For example, the archival job may start with an oldest snapshot which has not been transmitted to an archive location, and the archival job may match each snapshot with an applicable archival policy based on the snapshot age (e.g., based on a timestamp of the snapshot) and frequency. If a snapshot's frequency cannot be determined (for example, in some cases, the DMS 110-b may tag snapshots with frequencies after storing the snapshots in the cluster of storage nodes), the snapshot without may be skipped by the archival job (e.g., until a later time when the snapshot includes a frequency tag). A snapshot may be matched with no archival, one archival policy, two archival policies, or more.

At 320, the DMS 110-b may transmit snapshots matched with an archival policy associated with the first archive location 191-c to the first archive location 191-c. At 325, the DMS 110-b may transmit snapshots matched with an archival policy associated with the second archive location 191-d to the second archive location 191-d. Some snapshots may not be matched with either the first archive location 191-c or the second archive location 191-d (or any archive location). Some snapshots may be matched with one of the first archive location 191-c or the second archive location 191-d. Some snapshots may be matched with both the first archive location 191-c and the second archive location 191-d. Snapshots matched and transmitted to both the first archive location 191-c and the second archive location 191-d may be stored independently at the first archive location 191-c and the second archive location 191-d. For example, a snapshot may expire at different times at the first archive location 191-c and the second archive location 191-d in accordance with an SLA. A tiering of archived snapshots may be managed independently across the two locations as per the archival policy configuration. The DMS 110-b may record which snapshots are transmitted to which archive locations.

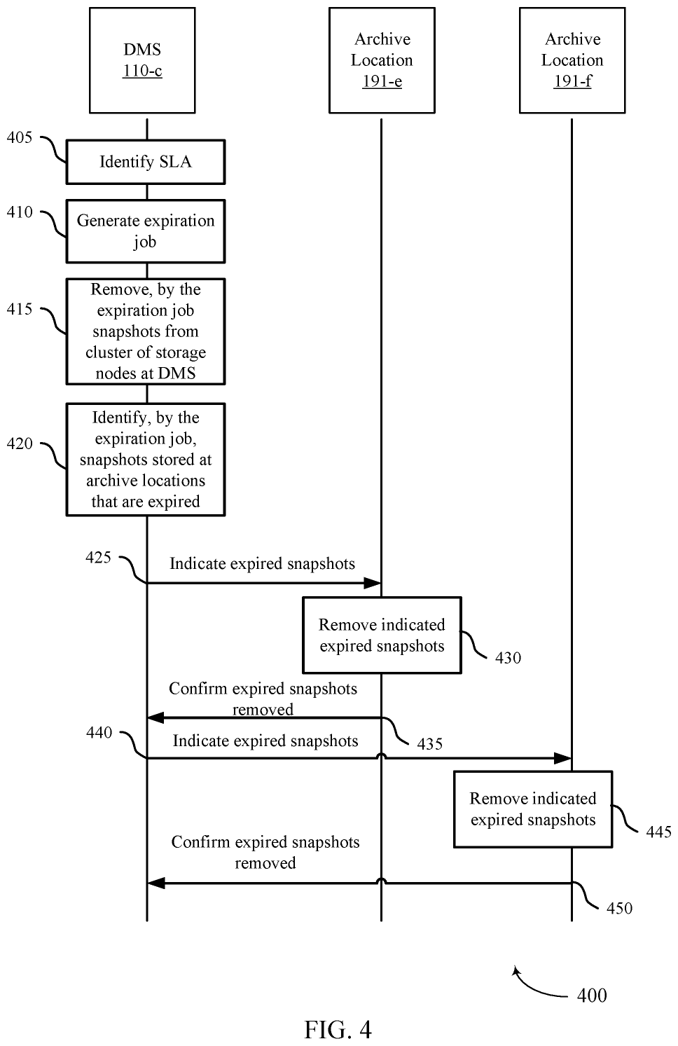

FIG. 4 illustrates an example of a process flow 400 that supports archiving computing snapshots to multiple locations in accordance with an SLA in accordance with aspects of the present disclosure. The process flow 400 may include a DMS 110-c, which may be an example of a DMS 110 as described herein. The process flow 400 may include a first archive location 191-e and a second archive location 191-f, which may be an example of a computing system 105 as described herein. In the following description of the process flow 400, the operations between the DMS 110-c, the first archive location 191-e, and the second archive location 191-f may be transmitted in a different order than the example order shown, or the operations performed by the DMS 110-c, the first archive location 191-e, and the second archive location 191-f may be performed in different orders or at different times. Some operations may also be omitted from the process flow 400, and other operations may be added to the process flow 400.

At 405, the DMS 110-c may identify an SLA for a target computing object of the computing system.

At 410, the DMS 110-c may generate an expiration job for the target computing object of the computing system.

At 415, the expiration job may remove (e.g., delete) snapshots stored at the cluster of storage nodes of the DMS 110-c that are past a local retention duration specified in the SLA that have been transmitted to an archive location. If a snapshot is not matched with an archival policy (e.g., the snapshot is only specified by the SLA to be stored locally), the expiration job may determine that a snapshot stored at the cluster of storage nodes of the DMS 110-c is expired if the snapshot is past an expiration duration specified in the SLA. In some cases, the expiration job may identify other criteria specified in an SLA as well as retention periods to determine whether a snapshot has expired.

At 420, the expiration job may identify for each snapshot stored in archive locations in accordance with the SLA, whether the respective snapshot is expired based on retention durations specified in the SLA. In some cases, the expiration job may identify other criteria specified in an SLA as well as retention periods to determine whether a snapshot has expired.

At 425, the DMS 110-c may transmit, to the first archive location 191-e, an indication of which snapshots stored at the first archive location 191-e are expired. At 430, the first archive location 191-e may remove (e.g., delete) the indicated expired snapshots. At 435, the first archive location 191-e may transmit a message to the DMS 110-c confirming that the indicated snapshots were deleted.

At 440, the DMS 110-c may transmit, to the second archive location 191-f, an indication of which snapshots stored at the second archive location 191-f are expired. At 445, the second archive location 191-f may remove (e.g., delete) the indicated expired snapshots. At 450, the second archive location 191-f may transmit a message to the DMS 110-c confirming that the indicated snapshots were deleted.

The retention durations for snapshots stored in the first archive location 191-e and the second archive location 191-f may be independent of each other. For example, a same snapshot stored in the first archive location 191-e and the second archive location 191-f may expire at different times in the first archive location 191-e and the second archive location 191-f.

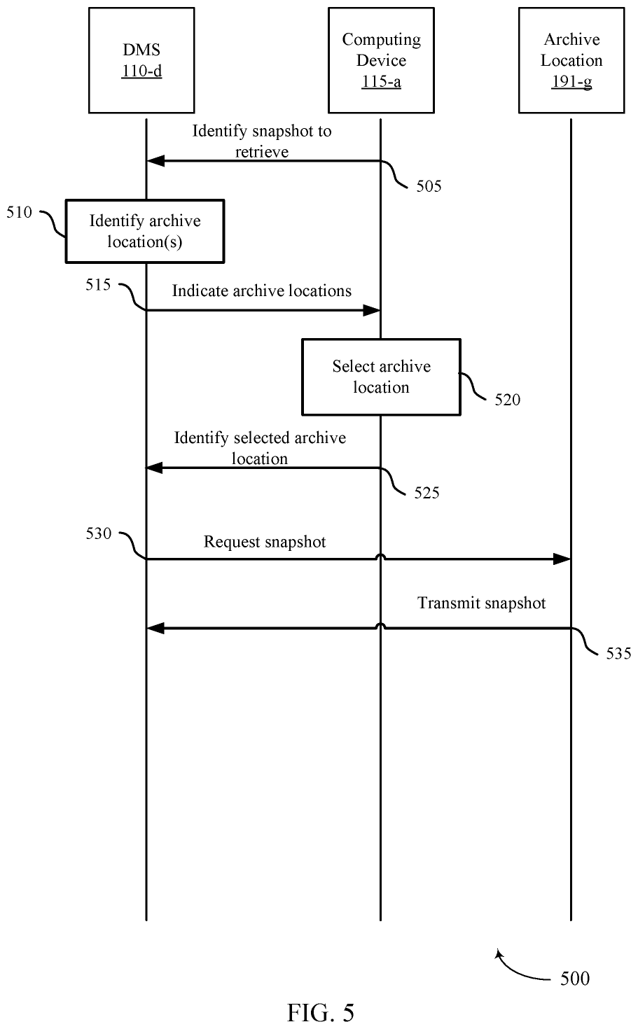

FIG. 5 illustrates an example of a process flow 500 that supports archiving computing snapshots to multiple locations in accordance with an SLA in accordance with aspects of the present disclosure. The process flow 500 may include a DMS 110-d, which may be an example of a DMS 110 as described herein. The process flow 500 may include a computing device 115-a, which may be an example of a computing device 115-a as described herein. The process flow 500 may include an archive location 191-g, which may be an example of an archive location 191 as described herein. In the following description of the process flow 500, the operations between the DMS 110-d, the computing device 115-a, and the archive location 191-g may be transmitted in a different order than the example order shown, or the operations performed by the DMS 110-d, the computing device 115-a, and the archive location 191-g. Some operations may also be omitted from the process flow 500, and other operations may be added to the process flow 500.

In the case that a snapshot is archived in multiple archive locations, a user may select an archive location from which to download a copy for recovery purposes (or other purposes, for example regulatory compliance). For example, at 505, a user may identify a particular snapshot to retrieve (e.g., based on a date and/or time). The computing device 115-a associated with the user may identify the indicated snapshot to the DMS 110-d.

At 510, the DMS 110-d may identify the archive location(s) where the indicated snapshot is stored. At 515, the DMS 110-d may provide an indication of the identified archive locations where the snapshot is stored to the computing device 115-a. For example, the computing device 115-a may present a listing of the archive locations where the snapshot is stored on an interface of the computing device 115-a.

At 520, the user may select, at the computing device 115-a, an archive location 191-g from the listing of archive locations from which to recover the snapshot. At 525, the computing device 115-a may indicate, to the DMS 110-d, the selected archive location 191-g.

At 530, the DMS 110-d may transmit a request to the archive location 191-g for the identified snapshot. At 535, the archive location 191-g may transmit the requested snapshot to the DMS 110-d. In some cases, based on the user request at 505, the DMS 110-d may use the snapshot to restore the associated computing system to a prior state. In some cases, based on the user request at 505, the DMS 110-d may transmit the snapshot to the computing device 115-a (e.g., so that the user can download the snapshot). Accordingly, based on a purpose of a snapshot retrieval request, a user may select which archive location to recover a snapshot from in order to optimize performance and/or cost. In some cases, if a snapshot is stored at more than one archive location, a user may connect to both archive locations (e.g., download the snapshot from both archive locations). In some cases, the DMS 110-d may provide a listing, to the computing device 115-a, of all snapshots stored at all archive locations and/or the cluster of storage nodes at the DMS 110-d for the computing object associated with the SLA in order to provide a unified view of the snapshots stored for the computing object. A user at the computing device 115-a may select to download any snapshot of all the stored snapshots of the computing object.

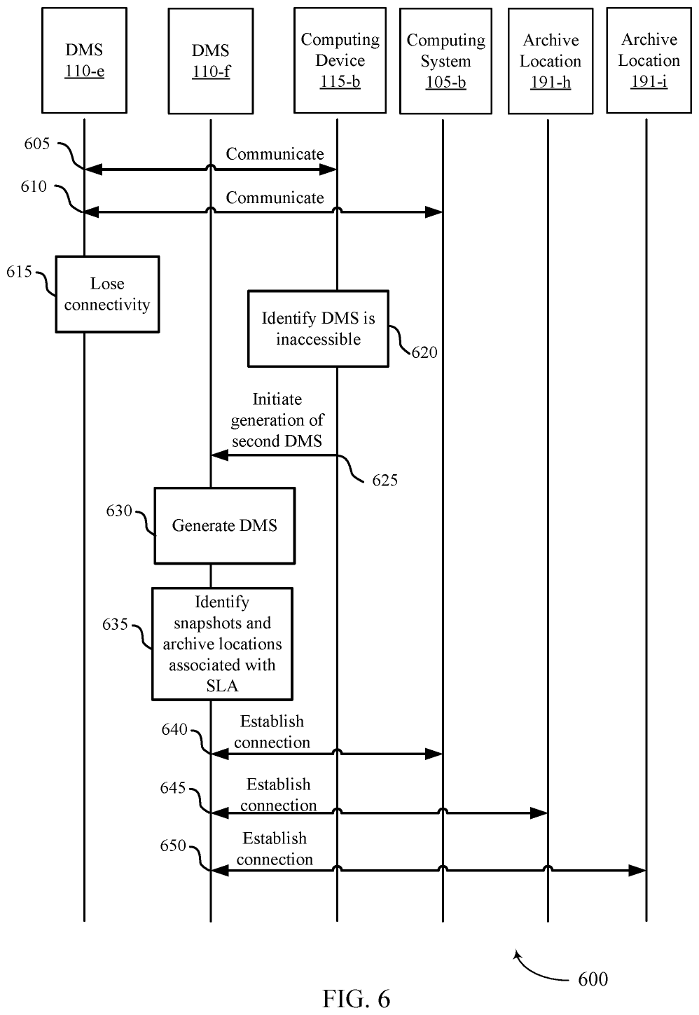

FIG. 6 illustrates an example of a process flow 600 that supports archiving computing snapshots to multiple locations in accordance with an SLA in accordance with aspects of the present disclosure. The process flow 600 may include a first DMS 110-e and a second DMS 110-f, which may be examples of a DMS 110 as described herein. The process flow 600 may include a computing device 115-b, which may be an example of a computing device 115-a as described herein. The process flow 600 may include a computing system 105-b, which may be an example of a computing system 105 as described herein. The process flow 600 may include a first archive location 191-h and a second archive location 191-i, which may be examples of an archive location 191 as described herein. In the following description of the process flow 600, the operations between the first DMS 110-e, the second DMS 1104, the computing device 115-b, computing system 105-b, the first archive location 191-h, and the second archive location 191-i may be transmitted in a different order than the example order shown, or the operations performed by the first DMS 110-e, the second DMS 110-f, the computing device 115-b, the first archive location 191-h, and the second archive location 191-i. Some operations may also be omitted from the process flow 600, and other operations may be added to the process flow 600.

At 605, the computing device 115-b may communicate with the first DMS 110-e. For example, the computing device 115-b may communicate with the first DMS 110-e regarding snapshots for a target computing object of the computing system 105-b in accordance with a given SLA.

At 610, the first DMS 110-e may communicate with the computing system 105-b, for example to obtain snapshots of the target computing object of the computing system 105-b in accordance with the SLA for the target computing object of the computing system 105-b.

At 615, the first DMS 110-e may become unavailable (e.g., the first DMS 110-e may fail, lose power, lose network connectivity, or otherwise be inaccessible to the computing device 115-b).

At 620, the computing device 115-b may identify that the first DMS 110-e is inaccessible. In some cases, the computing system 105-b may identify that the first DMS 110-e is inaccessible, and the computing system 105-b may notify the computing device 115-b (e.g., a user at the computing device 115-b) that the DMS 110-e is unavailable.

In response to identifying that the DMS 110-e is unavailable, at 625 the computing device 115-b (e.g., a user at the computing device 115-b) may initiate generate of a second DMS 110-f. The computing device 115-b may indicate the target computing object of the computing system 105-b and the SLA definition associated with the target computing object of the computing system 105-b.

At 630, the second DMS 110-f may be generated. At 635, the second DMS 110-f may identify the archive locations (e.g., the first archive location 191-h and the second archive location 191-i associated with the SLA definition for the target computing object of the computing system 105-b. In some cases, the second DMS 110-f may identify the snapshots of the target computing object of the computing system 105-b stored in the first archive location 191-h and the second archive location 191-i.

At 640, the second DMS 110-f may establish a connection with the computing system 105-b, for example to capture snapshots of the target computing object of the computing system 105-b in accordance with the SLA definition.

At 645, the second DMS 110-f may establish a connection with the first archive location 191-h. At 650, the second DMS 110-f may establish a connection with the second archive location 191-i. Accordingly, the second DMS 110-f may retrieve snapshots of the target computing object of the computing system 105-b from the first archive location 191-h and/or the second archive location 191-i as described herein, and the second DMS 110-f may indicate expired snapshots to the first archive location 191-h and/or the second archive location 191-i as described herein. In some cases, the first archive location 191-h and/or the second archive location 191-i may identify to the second DMS 110-f which snapshots stored at the respective first archive location 191-h and/or second archive location 191-i are associated with the target computing object of the computing system 105-b. For example, when establishing the connection at 645 and 650, the second DMS 110-f may identify the target computing object of the computing system 105-b, and in response the first archive location 191-h and/or second archive location 191-i may identify the snapshots of the target computing object of the computing system 105-b that are stored at the respective first archive location 191-h and/or second archive location 191-i. Accordingly, the second DMS 110-f may identify the archived snapshots of the target computing object of the computing system 105-b.

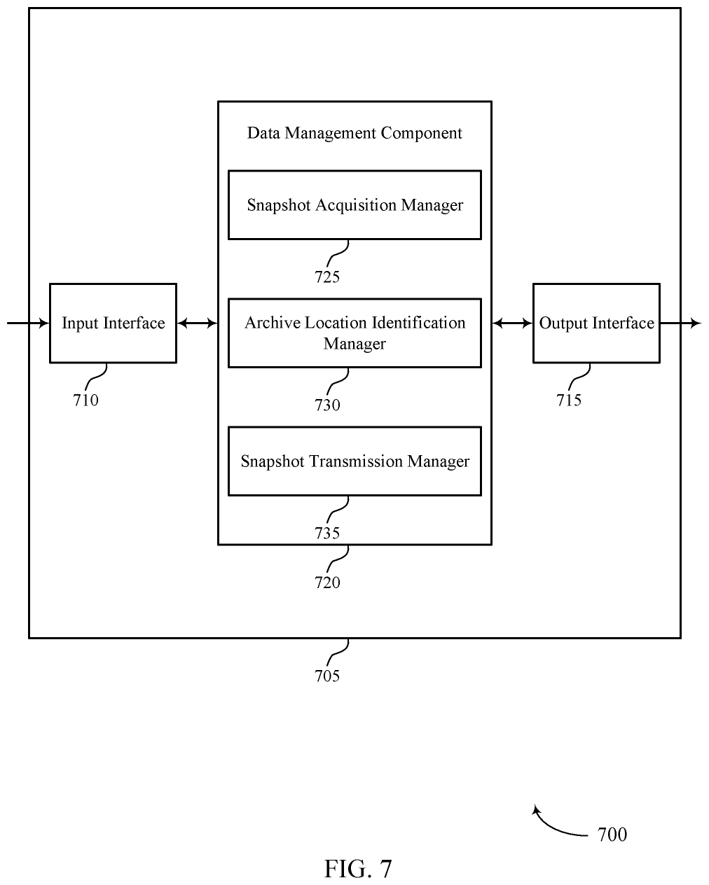

FIG. 7 shows a block diagram 700 of a system 705 that supports archiving computing snapshots to multiple locations in accordance with an SLA in accordance with aspects of the present disclosure. In some examples, the system 705 may be an example of aspects of one or more components described with reference to FIG. 1, such as a DMS 110. The system 705 may include an input interface 710, an output interface 715, and a data management component 720. The system 705 may also include one or more processors. Each of these components may be in communication with one another (e.g., via one or more buses, communications links, communications interfaces, or any combination thereof).

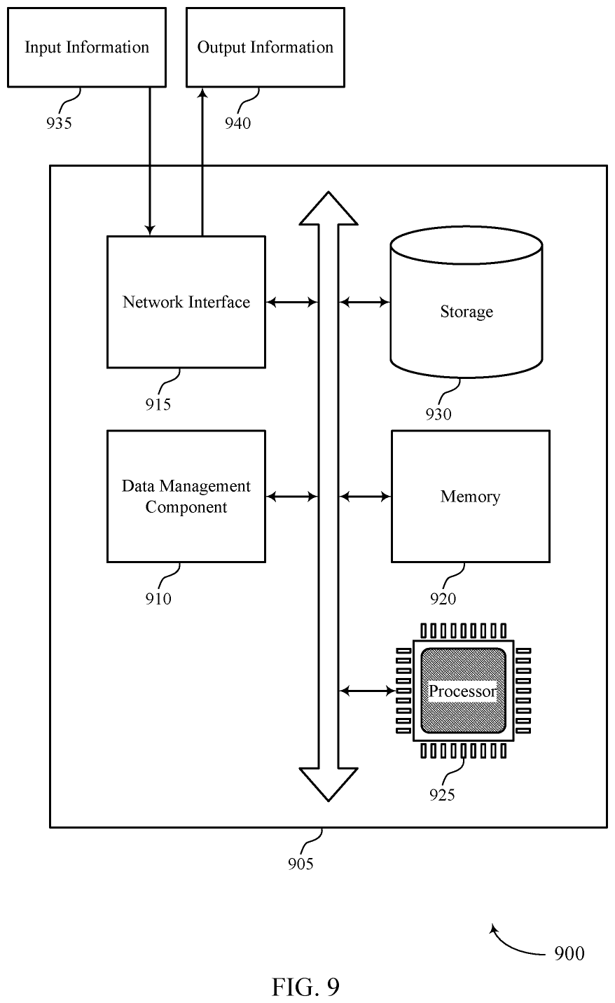

The input interface 710 may manage input signaling for the system 705. For example, the input interface 710 may receive input signaling (e.g., messages, packets, data, instructions, commands, or any other form of encoded information) from other systems or devices. The input interface 710 may send signaling corresponding to (e.g., representative of or otherwise based on) such input signaling to other components of the system 705 for processing. For example, the input interface 710 may transmit such corresponding signaling to the data management component 720 to support archiving computing snapshots to multiple locations in accordance with an SLA. In some cases, the input interface 710 may be a component of a network interface 915 as described with reference to FIG. 9.

The output interface 715 may manage output signaling for the system 705. For example, the output interface 715 may receive signaling from other components of the system 705, such as the data management component 720, and may transmit such output signaling corresponding to (e.g., representative of or otherwise based on) such signaling to other systems or devices. In some cases, the output interface 715 may be a component of a network interface 915 as described with reference to FIG. 9.

The data management component 720 may include a snapshot acquisition manager 725, an archive location identification manager 730, a snapshot transmission manager 735, or any combination thereof. In some examples, the data management component 720, or various components thereof, may be configured to perform various operations (e.g., receiving, monitoring, transmitting) using or otherwise in cooperation with the input interface 710, the output interface 715, or both. For example, the data management component 720 may receive information from the input interface 710, send information to the output interface 715, or be integrated in combination with the input interface 710, the output interface 715, or both to receive information, transmit information, or perform various other operations as described herein.

The snapshot acquisition manager 725 may be configured as or otherwise support a means for obtaining, at a DMS configured to interface with a computing object, snapshots of the computing object that are associated with respective frequency and archival policy parameters. The archive location identification manager 730 may be configured as or otherwise support a means for identifying by the DMS, for the snapshots, one or more respective archive locations from among a set of two or more candidate archive locations based on the respective frequency and archival policy parameters of the respective snapshots. The snapshot transmission manager 735 may be configured as or otherwise support a means for transmitting the snapshots from the DMS to the one or more respective identified archive locations.

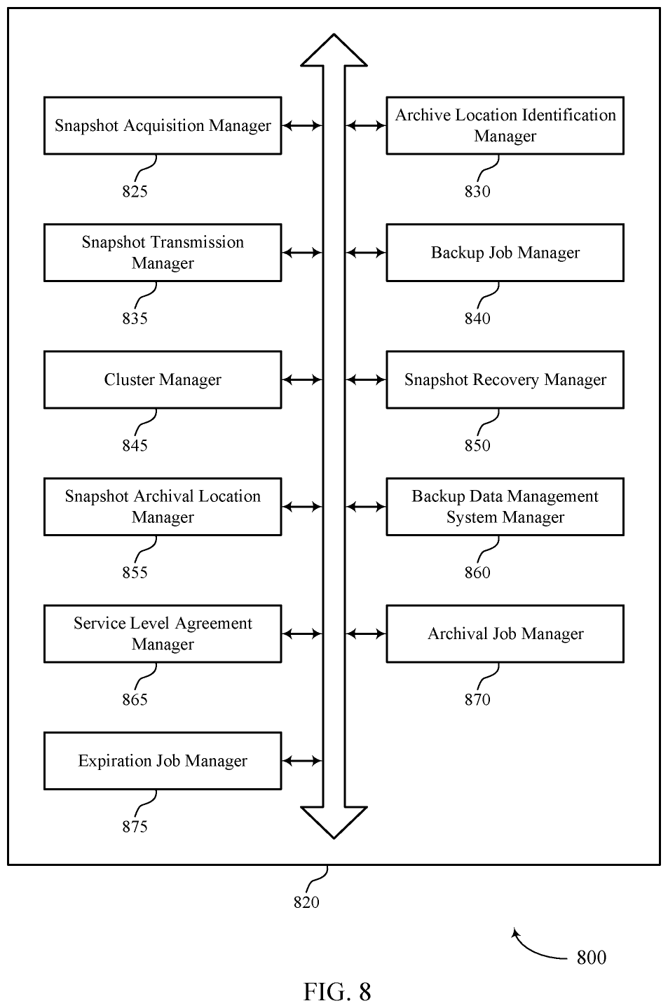

FIG. 8 shows a block diagram 800 of a data management component 820 that supports archiving computing snapshots to multiple locations in accordance with an SLA in accordance with aspects of the present disclosure. The data management component 820 may be an example of or include aspects of a data management component 720 as described herein. The data management component 820, or various components thereof, may be an example of means for performing various aspects of techniques for archiving computing snapshots to multiple locations in accordance with an SLA as described herein. For example, the data management component 820 may include a snapshot acquisition manager 825, an archive location identification manager 830, a snapshot transmission manager 835, a backup job manager 840, a cluster manager 845, a snapshot recovery manager 850, a snapshot archival location manager 855, a backup DMS manager 860, an SLA manager 865, an archival job manager 870, an expiration job manager 875, or any combination thereof. Each of these components may communicate, directly or indirectly, with one another (e.g., via one or more buses, communications links, communications interfaces, or any combination thereof).

The snapshot acquisition manager 825 may be configured as or otherwise support a means for obtaining, at a DMS configured to interface with a computing object, snapshots of the computing object that are associated with respective frequency and archival policy parameters. The archive location identification manager 830 may be configured as or otherwise support a means for identifying by the DMS, for the snapshots, one or more respective archive locations from among a set of two or more candidate archive locations based on the respective frequency and archival policy parameters of the respective snapshots. The snapshot transmission manager 835 may be configured as or otherwise support a means for transmitting the snapshots from the DMS to the one or more respective identified archive locations.

In some examples, to support obtaining the snapshots of the computing object, the backup job manager 840 may be configured as or otherwise support a means for generating, by the DMS, a backup job for the computing object. In some examples, to support obtaining the snapshots of the computing object, the backup job manager 840 may be configured as or otherwise support a means for capturing, via the backup job, the snapshots of the computing object based on an SLA definition for the computing object, the SLA definition including the frequency and archival policy parameters.

In some examples, the SLA manager 865 may be configured as or otherwise support a means for receiving, at the DMS, an indication of the SLA definition.

In some examples, the backup job manager 840 may be configured as or otherwise support a means for tagging, by the backup job, the snapshots with the respective frequency and archival policy parameters according to the SLA definition for the computing object.

In some examples, the backup job manager 840 may be configured as or otherwise support a means for tagging, by the backup job, a first snapshot of the snapshots with both a first parameter and a second parameter of the archival policy parameters, where the first parameter is associated with a first archive location of the set of two or more candidate archive locations and the second parameter is associated with a second archive location of the set of two or more candidate archive locations, and where transmitting the snapshots from the DMS to the one or more respective identified archive locations includes transmitting the first snapshot to both the first archive location and the second archive location.

In some examples, the cluster manager 845 may be configured as or otherwise support a means for storing the snapshots in a cluster of storage nodes at the DMS.

In some examples, to support identifying one or more respective archive locations, the archival job manager 870 may be configured as or otherwise support a means for generating, by the DMS based on a periodicity parameter, an archival job for the cluster of storage nodes. In some examples, to support identifying one or more respective archive locations, the archival job manager 870 may be configured as or otherwise support a means for determining, by the archival job, for the snapshots stored in the cluster of storage nodes at the DMS, the one or more respective archive locations based on the respective frequency and archival policy parameters of the snapshots stored in the cluster of storage nodes.

In some examples, the expiration job manager 875 may be configured as or otherwise support a means for generating, by the DMS based on a periodicity parameter, an expiration job for the computing object. In some examples, the expiration job manager 875 may be configured as or otherwise support a means for identifying, by the expiration job based on the respective frequency parameters, that one or more snapshots of the snapshots transmitted to the one or more respective identified archive locations are expired. In some examples, the expiration job manager 875 may be configured as or otherwise support a means for transmitting an indication to the one or more respective identified archive locations that the one or more snapshots are expired.

In some examples, the expiration job manager 875 may be configured as or otherwise support a means for generating, by the DMS based on a periodicity parameter, an expiration job for the computing object. In some examples, the expiration job manager 875 may be configured as or otherwise support a means for removing, by the expiration job, one or more snapshots from the cluster of storage nodes at the DMS after transmitting the snapshots to the one or more respective identified archive locations in accordance with respective archival policy parameters of the one or more snapshots.

In some examples, the snapshot recovery manager 850 may be configured as or otherwise support a means for receiving a request to retrieve a first snapshot of the snapshots for the computing object, where the first snapshot is stored in two or more archive locations from among the set of two or more candidate archive locations, the request indicating a recovery purpose for the first snapshot. In some examples, the snapshot recovery manager 850 may be configured as or otherwise support a means for retrieving the first snapshot from a first archive of the two or more archive locations in response to the request to retrieve, the first archive location identified based on the indicated recovery purpose.

In some examples, the snapshot recovery manager 850 may be configured as or otherwise support a means for receiving a request to restore the computing object using a first snapshot of the snapshots. In some examples, the snapshot archival location manager 855 may be configured as or otherwise support a means for providing a listing of the one or more respective identified archive locations for the first snapshot in response to the request to restore. In some examples, the snapshot recovery manager 850 may be configured as or otherwise support a means for receiving, after providing the listing, a selection of a first archive location of the one or more respective identified archive locations for the first snapshot. In some examples, the snapshot recovery manager 850 may be configured as or otherwise support a means for retrieving the first snapshot from the first archive location in response to the selection of the first archive location.

In some examples, a first archive location of the set of two or more candidate archive locations includes a first storage environment associated with a long-term retention parameter of the archival policy parameters. In some examples, a second archive location of the set of two or more candidate archive locations includes a second storage environment associated with a disaster recovery parameter of the archival policy parameters.

In some examples, the backup DMS manager 860 may be configured as or otherwise support a means for detecting, by a second DMS, an unavailability of the DMS. In some examples, the backup DMS manager 860 may be configured as or otherwise support a means for identifying, by the second DMS, the one or more respective identified archive locations for the snapshots based on the unavailability of the data management system. In some examples, the backup DMS manager 860 may be configured as or otherwise support a means for retrieving, by the second DMS, the snapshots from the one or more respective identified archive locations.

FIG. 9 shows a block diagram 900 of a system 905 that supports archiving computing snapshots to multiple locations in accordance with an SLA in accordance with aspects of the present disclosure.

The system 905 may be an example of or include aspects of a system 705 as described herein. The system 905 may include components for data management, including components such as a data management component 910, a network interface 915, memory 920, processor 925, and storage 930. These components may be in electronic communication or otherwise coupled with each other (e.g., operatively, communicatively, functionally, electronically, electrically; via one or more buses, communications links, communications interfaces, or any combination thereof). Additionally, the components of the system 905 may comprise corresponding physical components or may be implemented as corresponding virtual components (e.g., components of one or more virtual machines). In some examples, the system 905 may be an example of aspects of one or more components described with reference to FIG. 1, such as a DMS 110.

The network interface 915 may enable the system 905 to exchange information (e.g., input information 935, output information 940, or both) with other systems or devices (not shown). For example, the network interface 915 may enable the system 905 to connect to a network (e.g., a network 120 as described herein). The network interface 915 may include one or more wireless network interfaces, one or more wired network interfaces, or any combination thereof. In some examples, the network interface 915 may be an example of may be an example of aspects of one or more components described with reference to FIG. 1, such as one or more network interfaces 165.

Memory 920 may include RAM, ROM, or both. The memory 920 may store computer-readable, computer-executable software including instructions that, when executed, cause the processor 925 to perform various functions described herein. In some cases, the memory 920 may contain, among other things, a basic input/output system (BIOS), which may control basic hardware or software operation such as the interaction with peripheral components or devices. In some cases, the memory 920 may be an example of aspects of one or more components described with reference to FIG. 1, such as one or more memories 175.

The processor 925 may include an intelligent hardware device, (e.g., a general-purpose processor, a digital signal processor (DSP), a CPU, a microcontroller, an application-specific integrated circuit (ASIC), a field programmable gate array (FPGA), a programmable logic device, a discrete gate or transistor logic component, a discrete hardware component, or any combination thereof). The processor 925 may be configured to execute computer-readable instructions stored in a memory 920 to perform various functions (e.g., functions or tasks supporting archiving computing snapshots to multiple locations in accordance with an SLA). Though a single processor 925 is depicted in the example of FIG. 9, it is to be understood that the system 905 may include any quantity of one or more of processors 925 and that a group of processors 925 may collectively perform one or more functions ascribed herein to a processor, such as the processor 925. In some cases, the processor 925 may be an example of aspects of one or more components described with reference to FIG. 1, such as one or more processors 170.

Storage 930 may be configured to store data that is generated, processed, stored, or otherwise used by the system 905. In some cases, the storage 930 may include one or more HDDs, one or more SDDs, or both. In some examples, the storage 930 may be an example of a single database, a distributed database, multiple distributed databases, a data store, a data lake, or an emergency backup database. In some examples, the storage 930 may be an example of one or more components described with reference to FIG. 1, such as one or more network disks 180.

For example, the data management component 910 may be configured as or otherwise support a means for obtaining, at a DMS configured to interface with a computing object, snapshots of the computing object that are associated with respective frequency and archival policy parameters. The data management component 910 may be configured as or otherwise support a means for identifying by the DMS, for the snapshots, one or more respective archive locations from among a set of two or more candidate archive locations based on the respective frequency and archival policy parameters of the respective snapshots. The data management component 910 may be configured as or otherwise support a means for transmitting the snapshots from the DMS to the one or more respective identified archive locations.

By including or configuring the data management component 910 in accordance with examples as described herein, the system 905 may support techniques for archiving computing snapshots to multiple locations in accordance with an SLA, which may provide one or more benefits such as, for example, improved reliability, reduced latency, improved user experience, more efficient utilization of computing resources, network resources or both, among other possibilities.

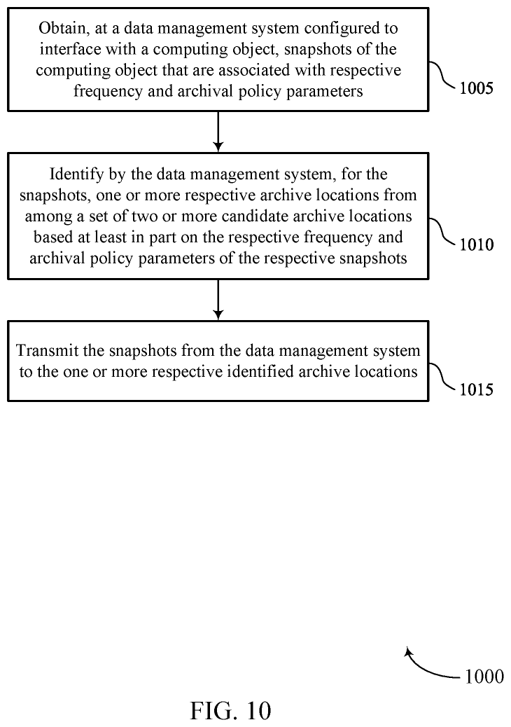

FIG. 10 shows a flowchart illustrating a method 1000 that supports archiving computing snapshots to multiple locations in accordance with an SLA in accordance with aspects of the present disclosure. The operations of the method 1000 may be implemented by a system or its components as described herein. For example, the operations of the method 1000 may be performed by a DMS as described with reference to FIGS. 1 through 9. In some examples, a DMS may execute a set of instructions to control the functional elements of the DMS to perform the described functions. Additionally, or alternatively, the DMS may perform aspects of the described functions using special-purpose hardware.

At 1005, the method may include obtaining, at a DMS configured to interface with a computing object, snapshots of the computing object that are associated with respective frequency and archival policy parameters. The operations of 1005 may be performed in accordance with examples as disclosed herein. In some examples, aspects of the operations of 1005 may be performed by a snapshot acquisition manager 825 as described with reference to FIG. 8.

At 1010, the method may include identifying by the DMS, for the snapshots, one or more respective archive locations from among a set of two or more candidate archive locations based on the respective frequency and archival policy parameters of the respective snapshots. The operations of 1010 may be performed in accordance with examples as disclosed herein. In some examples, aspects of the operations of 1010 may be performed by an archive location identification manager 830 as described with reference to FIG. 8.

At 1015, the method may include transmitting the snapshots from the DMS to the one or more respective identified archive locations. The operations of 1015 may be performed in accordance with examples as disclosed herein. In some examples, aspects of the operations of 1015 may be performed by a snapshot transmission manager 835 as described with reference to FIG. 8.

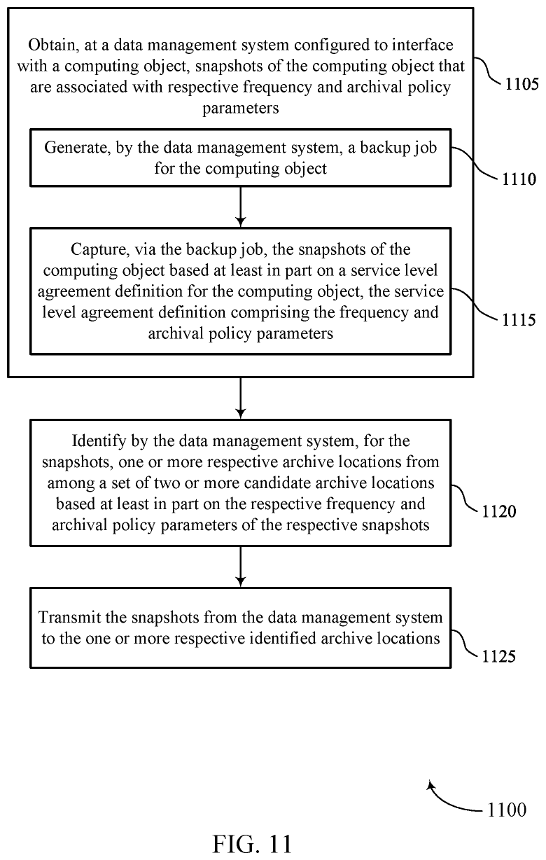

FIG. 11 shows a flowchart illustrating a method 1100 that supports archiving computing snapshots to multiple locations in accordance with an SLA in accordance with aspects of the present disclosure. The operations of the method 1100 may be implemented by a system or its components as described herein. For example, the operations of the method 1100 may be performed by a DMS as described with reference to FIGS. 1 through 9. In some examples, a DMS may execute a set of instructions to control the functional elements of the DMS to perform the described functions. Additionally, or alternatively, the DMS may perform aspects of the described functions using special-purpose hardware.

At 1105, the method may include obtaining, at a DMS configured to interface with a computing object, snapshots of the computing object that are associated with respective frequency and archival policy parameters. The operations of 1105 may be performed in accordance with examples as disclosed herein. In some examples, aspects of the operations of 1105 may be performed by a snapshot acquisition manager 825 as described with reference to FIG. 8.

Obtaining the snapshots of the computing object may include, at 1110, generating, by the DMS, a backup job for the computing object. The operations of 1110 may be performed in accordance with examples as disclosed herein. In some examples, aspects of the operations of 1110 may be performed by a backup job manager 840 as described with reference to FIG. 8.

Obtaining the snapshots of the computing object also may include, at 1115, capturing, via the backup job, the snapshots of the computing object based on an SLA definition for the computing object, the SLA definition including the frequency and archival policy parameters. The operations of 1115 may be performed in accordance with examples as disclosed herein. In some examples, aspects of the operations of 1115 may be performed by a backup job manager 840 as described with reference to FIG. 8.

At 1120, the method may include identifying by the DMS, for the snapshots, one or more respective archive locations from among a set of two or more candidate archive locations based on the respective frequency and archival policy parameters of the respective snapshots. The operations of 1120 may be performed in accordance with examples as disclosed herein. In some examples, aspects of the operations of 1120 may be performed by an archive location identification manager 830 as described with reference to FIG. 8.

At 1125, the method may include transmitting the snapshots from the DMS to the one or more respective identified archive locations. The operations of 1125 may be performed in accordance with examples as disclosed herein. In some examples, aspects of the operations of 1125 may be performed by a snapshot transmission manager 835 as described with reference to FIG. 8.

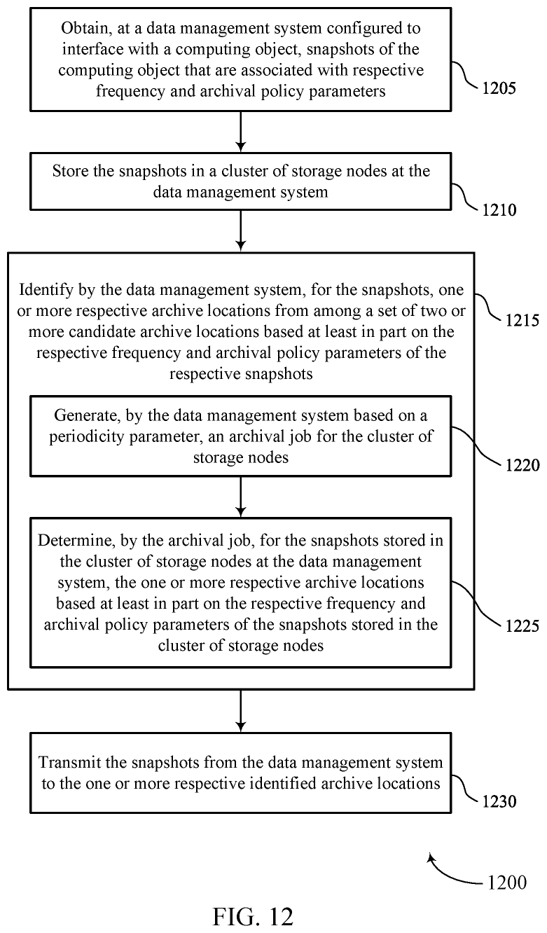

FIG. 12 shows a flowchart illustrating a method 1200 that supports archiving computing snapshots to multiple locations in accordance with an SLA in accordance with aspects of the present disclosure. The operations of the method 1200 may be implemented by a system or its components as described herein. For example, the operations of the method 1200 may be performed by a DMS as described with reference to FIGS. 1 through 9. In some examples, a DMS may execute a set of instructions to control the functional elements of the DMS to perform the described functions. Additionally, or alternatively, the DMS may perform aspects of the described functions using special-purpose hardware.

At 1205, the method may include obtaining, at a DMS configured to interface with a computing object, snapshots of the computing object that are associated with respective frequency and archival policy parameters. The operations of 1205 may be performed in accordance with examples as disclosed herein. In some examples, aspects of the operations of 1205 may be performed by a snapshot acquisition manager 825 as described with reference to FIG. 8.

At 1210, the method may include storing the snapshots in a cluster of storage nodes at the DMS. The operations of 1210 may be performed in accordance with examples as disclosed herein. In some examples, aspects of the operations of 1210 may be performed by a cluster manager 845 as described with reference to FIG. 8.

At 1215, the method may include identifying by the DMS, for the snapshots, one or more respective archive locations from among a set of two or more candidate archive locations based on the respective frequency and archival policy parameters of the respective snapshots. The operations of 1215 may be performed in accordance with examples as disclosed herein. In some examples, aspects of the operations of 1215 may be performed by an archive location identification manager 830 as described with reference to FIG. 8.

Identifying the one or more respective archive locations may include, at 1220, generating, by the DMS based on a periodicity parameter, an archival job for the cluster of storage nodes. The operations of 1220 may be performed in accordance with examples as disclosed herein. In some examples, aspects of the operations of 1220 may be performed by an archival job manager 870 as described with reference to FIG. 8.

Identifying the one or more respective archive locations also may include, at 1225, determining, by the archival job, for the snapshots stored in the cluster of storage nodes at the DMS, the one or more respective archive locations based on the respective frequency and archival policy parameters of the snapshots stored in the cluster of storage nodes. The operations of 1225 may be performed in accordance with examples as disclosed herein. In some examples, aspects of the operations of 1225 may be performed by an archival job manager 870 as described with reference to FIG. 8.

At 1230, the method may include transmitting the snapshots from the DMS to the one or more respective identified archive locations. The operations of 1230 may be performed in accordance with examples as disclosed herein. In some examples, aspects of the operations of 1230 may be performed by a snapshot transmission manager 835 as described with reference to FIG. 8.

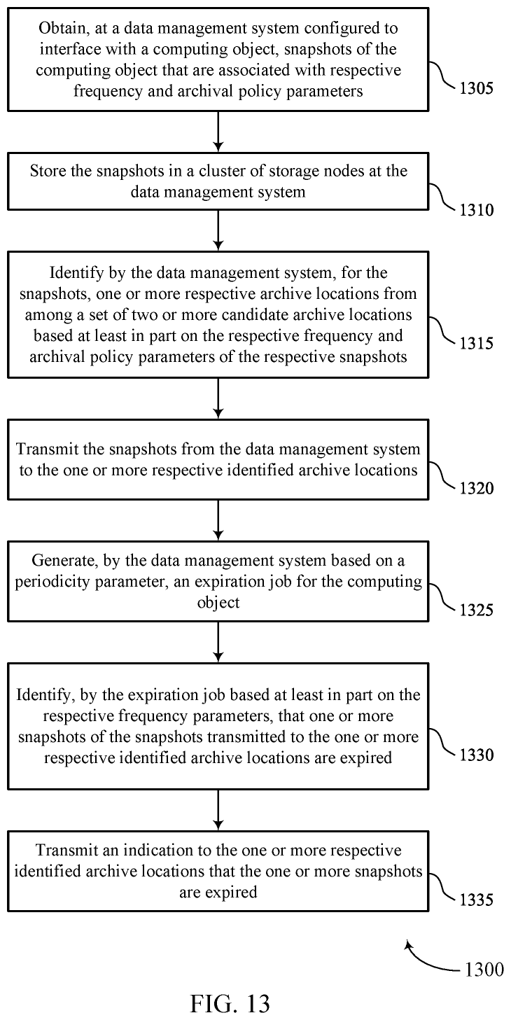

FIG. 13 shows a flowchart illustrating a method 1300 that supports archiving computing snapshots to multiple locations in accordance with an SLA in accordance with aspects of the present disclosure. The operations of the method 1300 may be implemented by a system or its components as described herein. For example, the operations of the method 1300 may be performed by a DMS as described with reference to FIGS. 1 through 9. In some examples, a DMS may execute a set of instructions to control the functional elements of the DMS to perform the described functions. Additionally, or alternatively, the DMS may perform aspects of the described functions using special-purpose hardware.

At 1305, the method may include obtaining, at a DMS configured to interface with a computing object, snapshots of the computing object that are associated with respective frequency and archival policy parameters. The operations of 1305 may be performed in accordance with examples as disclosed herein. In some examples, aspects of the operations of 1305 may be performed by a snapshot acquisition manager 825 as described with reference to FIG. 8.

At 1310, the method may include storing the snapshots in a cluster of storage nodes at the DMS. The operations of 1310 may be performed in accordance with examples as disclosed herein. In some examples, aspects of the operations of 1310 may be performed by a cluster manager 845 as described with reference to FIG. 8.

At 1315, the method may include identifying by the DMS, for the snapshots, one or more respective archive locations from among a set of two or more candidate archive locations based on the respective frequency and archival policy parameters of the respective snapshots. The operations of 1315 may be performed in accordance with examples as disclosed herein. In some examples, aspects of the operations of 1315 may be performed by an archive location identification manager 830 as described with reference to FIG. 8.

At 1320, the method may include transmitting the snapshots from the DMS to the one or more respective identified archive locations. The operations of 1320 may be performed in accordance with examples as disclosed herein. In some examples, aspects of the operations of 1320 may be performed by a snapshot transmission manager 835 as described with reference to FIG. 8.

At 1325, the method may include generating, by the DMS based on a periodicity parameter, an expiration job for the computing object. The operations of 1325 may be performed in accordance with examples as disclosed herein. In some examples, aspects of the operations of 1325 may be performed by an expiration job manager 875 as described with reference to FIG. 8.

At 1330, the method may include identifying, by the expiration job based on the respective frequency parameters, that one or more snapshots of the snapshots transmitted to the one or more respective identified archive locations are expired. The operations of 1330 may be performed in accordance with examples as disclosed herein. In some examples, aspects of the operations of 1330 may be performed by an expiration job manager 875 as described with reference to FIG. 8.

At 1335, the method may include transmitting an indication to the one or more respective identified archive locations that the one or more snapshots are expired. The operations of 1335 may be performed in accordance with examples as disclosed herein. In some examples, aspects of the operations of 1335 may be performed by an expiration job manager 875 as described with reference to FIG. 8.

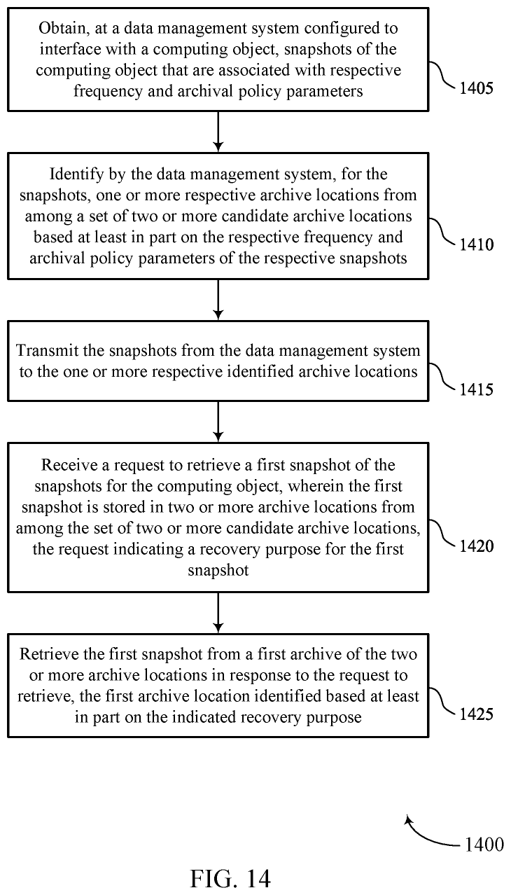

FIG. 14 shows a flowchart illustrating a method 1400 that supports archiving computing snapshots to multiple locations in accordance with an SLA in accordance with aspects of the present disclosure. The operations of the method 1400 may be implemented by a system or its components as described herein. For example, the operations of the method 1400 may be performed by a DMS as described with reference to FIGS. 1 through 9. In some examples, a DMS may execute a set of instructions to control the functional elements of the DMS to perform the described functions. Additionally, or alternatively, the DMS may perform aspects of the described functions using special-purpose hardware.

At 1405, the method may include obtaining, at a DMS configured to interface with a computing object, snapshots of the computing object that are associated with respective frequency and archival policy parameters. The operations of 1405 may be performed in accordance with examples as disclosed herein. In some examples, aspects of the operations of 1405 may be performed by a snapshot acquisition manager 825 as described with reference to FIG. 8.

At 1410, the method may include identifying by the DMS, for the snapshots, one or more respective archive locations from among a set of two or more candidate archive locations based on the respective frequency and archival policy parameters of the respective snapshots. The operations of 1410 may be performed in accordance with examples as disclosed herein. In some examples, aspects of the operations of 1410 may be performed by an archive location identification manager 830 as described with reference to FIG. 8.

At 1415, the method may include transmitting the snapshots from the DMS to the one or more respective identified archive locations. The operations of 1415 may be performed in accordance with examples as disclosed herein. In some examples, aspects of the operations of 1415 may be performed by a snapshot transmission manager 835 as described with reference to FIG. 8.

At 1420, the method may include receiving a request to retrieve a first snapshot of the snapshots for the computing object, where the first snapshot is stored in two or more archive locations from among the set of two or more candidate archive locations, the request indicating a recovery purpose for the first snapshot. The operations of 1420 may be performed in accordance with examples as disclosed herein. In some examples, aspects of the operations of 1420 may be performed by a snapshot recovery manager 850 as described with reference to FIG. 8.

At 1425, the method may include retrieving the first snapshot from a first archive of the two or more archive locations in response to the request to retrieve, the first archive location identified based on the indicated recovery purpose. The operations of 1425 may be performed in accordance with examples as disclosed herein. In some examples, aspects of the operations of 1425 may be performed by a snapshot recovery manager 850 as described with reference to FIG. 8.

A method is described. The method may include obtaining, at a DMS configured to interface with a computing object, snapshots of the computing object that are associated with respective frequency and archival policy parameters, identifying by the DMS, for the snapshots, one or more respective archive locations from among a set of two or more candidate archive locations based on the respective frequency and archival policy parameters of the respective snapshots, and transmitting the snapshots from the DMS to the one or more respective identified archive locations.

An apparatus is described. The apparatus may include at least one processor, memory coupled with the at least one processor, and instructions stored in the memory. The instructions may be executable by the at least one processor to cause the apparatus to obtain, at a DMS configured to interface with a computing object, snapshots of the computing object that are associated with respective frequency and archival policy parameters, identify by the DMS, for the snapshots, one or more respective archive locations from among a set of two or more candidate archive locations based on the respective frequency and archival policy parameters of the respective snapshots, and transmit the snapshots from the DMS to the one or more respective identified archive locations.

Another apparatus is described. The apparatus may include means for obtaining, at a DMS configured to interface with a computing object, snapshots of the computing object that are associated with respective frequency and archival policy parameters, means for identifying by the DMS, for the snapshots, one or more respective archive locations from among a set of two or more candidate archive locations based on the respective frequency and archival policy parameters of the respective snapshots, and means for transmitting the snapshots from the DMS to the one or more respective identified archive locations.

A non-transitory computer-readable medium storing code is described. The code may include instructions executable by at least one processor to obtain, at a DMS configured to interface with a computing object, snapshots of the computing object that are associated with respective frequency and archival policy parameters, identify by the DMS, for the snapshots, one or more respective archive locations from among a set of two or more candidate archive locations based on the respective frequency and archival policy parameters of the respective snapshots, and transmit the snapshots from the DMS to the one or more respective identified archive locations.

In some examples of the method, apparatuses, and non-transitory computer-readable medium described herein, operations, features, means, or instructions for obtaining the snapshots of the computing object may include operations, features, means, or instructions for generating, by the DMS, a backup job for the computing object and capturing, via the backup job, the snapshots of the computing object based on a service level agreement definition for the computing object, the service level agreement definition including the frequency and archival policy parameters.

Some examples of the method, apparatuses, and non-transitory computer-readable medium described herein may further include operations, features, means, or instructions for receiving, at the DMS, an indication of the service level agreement definition.

In some examples of the method, apparatuses, and non-transitory computer-readable medium described herein, tagging, by the backup job, the snapshots with the respective frequency and archival policy parameters according to the service level agreement definition for the computing object.

In some examples of the method, apparatuses, and non-transitory computer-readable medium described herein, tagging, by the backup job, a first snapshot of the snapshots with both a first parameter and a second parameter of the archival policy parameters, where the first parameter may be associated with a first archive location of the set of two or more candidate archive locations and the second parameter may be associated with a second archive location of the set of two or more candidate archive locations, and where transmitting the snapshots from the DMS to the one or more respective identified archive locations includes transmitting the first snapshot to both the first archive location and the second archive location.

Some examples of the method, apparatuses, and non-transitory computer-readable medium described herein may further include operations, features, means, or instructions for storing the snapshots in a cluster of storage nodes at the DMS.

In some examples of the method, apparatuses, and non-transitory computer-readable medium described herein, operations, features, means, or instructions for identifying one or more respective archive locations may include operations, features, means, or instructions for generating, by the DMS based on a periodicity parameter, an archival job for the cluster of storage nodes and determining, by the archival job, for the snapshots stored in the cluster of storage nodes at the DMS, the one or more respective archive locations based on the respective frequency and archival policy parameters of the snapshots stored in the cluster of storage nodes.

Some examples of the method, apparatuses, and non-transitory computer-readable medium described herein may further include operations, features, means, or instructions for generating, by the DMS based on a periodicity parameter, an expiration job for the computing object, identifying, by the expiration job based on the respective frequency parameters, that one or more snapshots of the snapshots transmitted to the one or more respective identified archive locations may be expired, and transmitting an indication to the one or more respective identified archive locations that the one or more snapshots may be expired.

Some examples of the method, apparatuses, and non-transitory computer-readable medium described herein may further include operations, features, means, or instructions for generating, by the DMS based on a periodicity parameter, an expiration job for the computing object and removing, by the expiration job, one or more snapshots from the cluster of storage nodes at the DMS after transmitting the snapshots to the one or more respective identified archive locations in accordance with respective archival policy parameters of the one or more snapshots.

Some examples of the method, apparatuses, and non-transitory computer-readable medium described herein may further include operations, features, means, or instructions for receiving a request to retrieve a first snapshot of the snapshots for the computing object, where the first snapshot may be stored in two or more archive locations from among the set of two or more candidate archive locations, the request indicating a recovery purpose for the first snapshot and retrieving the first snapshot from a first archive of the two or more archive locations in response to the request to retrieve, the first archive location identified based on the indicated recovery purpose.

Some examples of the method, apparatuses, and non-transitory computer-readable medium described herein may further include operations, features, means, or instructions for receiving a request to restore the computing object using a first snapshot of the snapshots, providing a listing of the one or more respective identified archive locations for the first snapshot in response to the request to restore, receiving, after providing the listing, a selection of a first archive location of the one or more respective identified archive locations for the first snapshot, and retrieving the first snapshot from the first archive location in response to the selection of the first archive location.

In some examples of the method, apparatuses, and non-transitory computer-readable medium described herein, a first archive location of the set of two or more candidate archive locations includes a first storage environment associated with a long-term retention parameter of the archival policy parameters and a second archive location of the set of two or more candidate archive locations includes a second storage environment associated with a disaster recovery parameter of the archival policy parameters.

Some examples of the method, apparatuses, and non-transitory computer-readable medium described herein may further include operations, features, means, or instructions for detecting, by a second DMS, an unavailability of the DMS, identifying, by the second DMS, the one or more respective identified archive locations for the snapshots based on the unavailability of the data management system, and retrieving, by the second DMS, the snapshots from the one or more respective identified archive locations.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
obtaining, at a data management system configured to interface with a computing object, snapshots of the computing object that are associated with respective frequency and archival policy parameters;
identifying by the data management system, for the snapshots, one or more respective archive locations from among a set of two or more candidate archive locations based at least in part on the respective frequency and archival policy parameters of the respective snapshots; and
transmitting the snapshots from the data management system to the one or more respective identified archive locations.

2. The method of claim 1, wherein obtaining the snapshots of the computing object comprises:
generating, by the data management system, a backup job for the computing object; and
capturing, via the backup job, the snapshots of the computing object based at least in part on a service level agreement definition for the computing object, the service level agreement definition comprising the frequency and archival policy parameters.

3. The method of claim 2, further comprising:
receiving, at the data management system, an indication of the service level agreement definition.

4. The method of claim 2, further comprising:
tagging, by the backup job, the snapshots with the respective frequency and archival policy parameters according to the service level agreement definition for the computing object.

5. The method of claim 4, further comprising:
tagging, by the backup job, a first snapshot of the snapshots with both a first parameter and a second parameter of the archival policy parameters, wherein the first parameter is associated with a first archive location of the set of two or more candidate archive locations and the second parameter is associated with a second archive location of the set of two or more candidate archive locations, and wherein transmitting the snapshots from the data management system to the one or more respective identified archive locations comprises transmitting the first snapshot to both the first archive location and the second archive location.

6. The method of claim 1, further comprising:
storing the snapshots in a cluster of storage nodes at the data management system.

7. The method of claim 6, wherein identifying one or more respective archive locations comprises:
generating, by the data management system based on a periodicity parameter, an archival job for the cluster of storage nodes; and
determining, by the archival job, for the snapshots stored in the cluster of storage nodes at the data management system, the one or more respective archive locations based at least in part on the respective frequency and archival policy parameters of the snapshots stored in the cluster of storage nodes.

8. The method of claim 6, further comprising:
generating, by the data management system based on a periodicity parameter, an expiration job for the computing object;
identifying, by the expiration job based at least in part on the respective frequency parameters, that one or more snapshots of the snapshots transmitted to the one or more respective identified archive locations are expired; and
transmitting an indication to the one or more respective identified archive locations that the one or more snapshots are expired.

9. The method of claim 6, further comprising:
generating, by the data management system based on a periodicity parameter, an expiration job for the computing object; and
removing, by the expiration job, one or more snapshots from the cluster of storage nodes at the data management system after transmitting the snapshots to the one or more respective identified archive locations in accordance with respective archival policy parameters of the one or more snapshots.

10. The method of claim 1, further comprising:
receiving a request to retrieve a first snapshot of the snapshots for the computing object, wherein the first snapshot is stored in two or more archive locations from among the set of two or more candidate archive locations, the request indicating a recovery purpose for the first snapshot; and
retrieving the first snapshot from a first archive of the two or more archive locations in response to the request to retrieve, the first archive location identified based at least in part on the indicated recovery purpose.

11. The method of claim 1, further comprising:
receiving a request to restore the computing object using a first snapshot of the snapshots;
providing a listing of the one or more respective identified archive locations for the first snapshot in response to the request to restore;
receiving, after providing the listing, a selection of a first archive location of the one or more respective identified archive locations for the first snapshot; and
retrieving the first snapshot from the first archive location in response to the selection of the first archive location.

12. The method of claim 1, wherein:
a first archive location of the set of two or more candidate archive locations comprises a first storage environment associated with a long-term retention parameter of the archival policy parameters, and
a second archive location of the set of two or more candidate archive locations comprises a second storage environment associated with a disaster recovery parameter of the archival policy parameters.

13. The method of claim 1, further comprising:
detecting, by a second data management system, an unavailability of the data management system;
identifying, by the second data management system, the one or more respective identified archive locations for the snapshots based at least in part on the unavailability of the data management system; and
retrieving, by the second data management system, the snapshots from the one or more respective identified archive locations.

14. An apparatus, comprising:
at least one processor;
memory coupled with the at least one processor; and
instructions stored in the memory and executable by the at least one processor to cause the apparatus to:
obtain, at a data management system configured to interface with a computing object, snapshots of the computing object that are associated with respective frequency and archival policy parameters;
identify by the data management system, for the snapshots, one or more respective archive locations from among a set of two or more candidate archive locations based at least in part on the respective frequency and archival policy parameters of the respective snapshots; and
transmit the snapshots from the data management system to the one or more respective identified archive locations.

15. The apparatus of claim 14, wherein, to obtain the snapshots of the computing object, the instructions are executable by the at least one processor to cause the apparatus to:
generate, by the data management system, a backup job for the computing object; and
capture, via the backup job, the snapshots of the computing object based at least in part on a service level agreement definition for the computing object, the service level agreement definition comprising the frequency and archival policy parameters.

16. The apparatus of claim 15, wherein the instructions are further executable by the at least one processor to cause the apparatus to:
receive, at the data management system, an indication of the service level agreement definition.

17. The apparatus of claim 15, wherein the instructions are further executable by the at least one processor to cause the apparatus to:
tag, by the backup job, the snapshots with the respective frequency and archival policy parameters accord to the service level agreement definition for the computing object.

18. The apparatus of claim 17, wherein the instructions are further executable by the at least one processor to cause the apparatus to:
tag, by the backup job, a first snapshot of the snapshots with both a first parameter and a second parameter of the archival policy parameters, wherein the first parameter be associated with a first archive location of the set of two or more candidate archive locations and the second parameter is associated with a second archive location of the set of two or more candidate archive locations, and wherein transmitting the snapshots from the data management system to the one or more respective identified archive locations comprises transmitting the first snapshot to both the first archive location and the second archive location.

19. The apparatus of claim 14, wherein the instructions are further executable by the at least one processor to cause the apparatus to:
store the snapshots in a cluster of storage nodes at the data management system.

20. A non-transitory computer-readable medium storing code, the code comprising instructions executable by at least one processor to:
obtain, at a data management system configured to interface with a computing object, snapshots of the computing object that are associated with respective frequency and archival policy parameters;
identify by the data management system, for the snapshots, one or more respective archive locations from among a set of two or more candidate archive locations based at least in part on the respective frequency and archival policy parameters of the respective snapshots; and
transmit the snapshots from the data management system to the one or more respective identified archive locations.
